(19) United States
(12) Patent Application Publication
(10) Pub. No.: US 2024/0412153 A1
(43) Pub. Date: Dec. 12, 2024

(54) COORDINATED MULTI-TRACKER REPORTING

(71) Applicant: QUALCOMM Incorporated, San Diego, CA (US)

(72) Inventors: Mark Aaron LINDNER, Broomfield, CO (US); Gang DING, San Diego, CA (US); Varun Amar REDDY, San Diego, CA (US); Gamini Dinesh GARG, Austin, TX (US)

(21) Appl. No.: 18/494,062

(22) Filed: Oct. 25, 2023

Related U.S. Application Data
(60) Provisional application No. 63/506,878, filed on Jun. 8, 2023.

(51) Int. Cl. G06Q 10/0833; H04W 4/029

(52) U.S. Cl. CPC G06Q 10/0833; H04W 4/029

(57) ABSTRACT

Disclosed are techniques for wireless communication. In an aspect, an asset tracking device receives a set of group scheduling parameters for a plurality of asset tracking devices assigned to a plurality of assets in a shipment, wherein the set of group scheduling parameters comprises a global wakeup start time and a time interval between consecutive wakeup times, wherein the shipment comprises a plurality of stops, including a starting stop, one or more intermediate stops, and an ending stop, and wherein each of the plurality of asset tracking devices has a target stop of the plurality of stops, and, at each wakeup time of at least a set of wakeup times of the consecutive wakeup times: obtains one or more positioning measurements, transmits the one or more positioning measurements, synchronizes a local clock of the asset tracking device to a global time protocol, and transitions to a sleep mode.

### CROSS-REFERENCE TO RELATED APPLICATIONS

The present Application for Patent claims the benefit of U.S. Provisional Application No. 63/506,878, entitled “COORDINATED MULTI-TRACKER REPORTING,” filed Jun. 8, 2023, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### DESCRIPTION OF THE RELATED ART

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by an asset tracking device includes receiving a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtaining one or more positioning measurements; transmitting the one or more positioning measurements; synchronizing a local clock of the asset tracking device to a global time protocol; and transitioning to a sleep mode.

In an aspect, a method of communication performed by a network entity includes receiving one or more measurements from at least one asset tracking device of a plurality of asset tracking devices assigned to a plurality of assets in a shipment, wherein the one or more measurements are associated with a potentially spurious asset tracking device; obtaining tracker information associated with the potentially spurious asset tracking device; determining, based on the tracker information, whether the potentially spurious asset tracking device is a spurious asset tracking device; and transmitting, based on a determination that the potentially spurious asset tracking device is a spurious asset tracking device, an alert indicating a presence of the spurious asset tracking device.

In an aspect, an asset tracking device includes one or more memories; one or more transceivers; and one or more processors communicatively coupled to the one or more memories and the one or more transceivers, the one or more processors, either alone or in combination, configured to: receive, via the one or more transceivers, a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtain one or more positioning measurements; transmit, via the one or more transceivers, the one or more positioning measurements; synchronize a local clock of the asset tracking device to a global time protocol; and transition to a sleep mode.

In an aspect, a network entity includes one or more memories; one or more transceivers; and one or more processors communicatively coupled to the one or more memories and the one or more transceivers, the one or more processors, either alone or in combination, configured to: receive, via the one or more transceivers, one or more measurements from at least one asset tracking device of a plurality of asset tracking devices assigned to a plurality of assets in a shipment, wherein the one or more measurements are associated with a potentially spurious asset tracking device; obtain tracker information associated with the potentially spurious asset tracking device; determine, based on the tracker information, whether the potentially spurious asset tracking device is a spurious asset tracking device; and transmit, via the one or more transceivers, based on a determination that the potentially spurious asset tracking device is a spurious asset tracking device, an alert indicating a presence of the spurious asset tracking device.

In an aspect, an asset tracking device includes means for receiving a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: means for obtaining one or more positioning measurements; means for transmitting the one or more positioning measurements; means for synchronizing a local clock of the asset tracking device to a global time protocol; and means for transitioning to a sleep mode.

In an aspect, a network entity includes means for receiving one or more measurements from at least one asset tracking device of a plurality of asset tracking devices assigned to a plurality of assets in a shipment, wherein the one or more measurements are associated with a potentially spurious asset tracking device; means for obtaining tracker information associated with the potentially spurious asset tracking device; means for determining, based on the tracker information, whether the potentially spurious asset tracking device is a spurious asset tracking device; and means for transmitting, based on a determination that the potentially spurious asset tracking device is a spurious asset tracking device, an alert indicating a presence of the spurious asset tracking device.

In an aspect, a non-transitory computer-readable medium stores computer-executable instructions that, when executed by an asset tracking device, cause the asset tracking device to: receive a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtain one or more positioning measurements; transmit the one or more positioning measurements; synchronize a local clock of the asset tracking device to a global time protocol; and transition to a sleep mode.

In an aspect, a non-transitory computer-readable medium stores computer-executable instructions that, when executed by a network entity, cause the network entity to: receive one or more measurements from at least one asset tracking device of a plurality of asset tracking devices assigned to a plurality of assets in a shipment, wherein the one or more measurements are associated with a potentially spurious asset tracking device; obtain tracker information associated with the potentially spurious asset tracking device; determine, based on the tracker information, whether the potentially spurious asset tracking device is a spurious asset tracking device; and transmit, based on a determination that the potentially spurious asset tracking device is a spurious asset tracking device, an alert indicating a presence of the spurious asset tracking device.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example scenario in which n trackers are transported along a route having m stops, according to aspects of the disclosure.

FIG. 5 is a diagram illustrating an example scenario in which additional peer-to-peer (P2P) information between trackers helps to derive a better position result for the second tracker, according to aspects of the disclosure.

FIG. 6 is a diagram illustrating an example technique for detecting external trackers using manufacturing/vendor-specific information, according to aspects of the disclosure.

FIG. 7 is a diagram illustrating an example technique for detecting external trackers using the authentic trackers themselves, according to aspects of the disclosure.

FIG. 8 is a diagram illustrating an example technique for detecting external trackers using the authentic trackers themselves, according to aspects of the disclosure.

FIG. 9 is a diagram illustrating example signaling aspects for cross-vendor external tracker detection, according to aspects of the disclosure.

FIG. 10 is a diagram illustrating an example messaging flow for cross-vendor external tracker detection, according to aspects of the disclosure.

FIG. 11 is a diagram illustrating another example messaging flow for cross-vendor external tracker detection, according to aspects of the disclosure.

FIGS. 12 and 13 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless communications. Some aspects more specifically relate to coordination among multiple asset trackers. In some examples, an asset tracking device receives a set of group scheduling parameters for a plurality of asset tracking devices, including the asset tracking device, assigned to a plurality of assets in a shipment. The set of group scheduling parameters may include a global wakeup start time and a time interval between consecutive wakeup times. The shipment may include a plurality of stops, including a starting stop, one or more intermediate stops, and an ending stop. Each of the plurality of asset tracking devices may have a target stop of the plurality of stops. At each wakeup time of at least a set of wakeup times of the consecutive wakeup times, the asset tracking device obtains one or more positioning measurements, transmits the one or more positioning measurements (to a server or a relay node), synchronizes a local clock of the asset tracking device to a global time protocol, and transitions to a sleep mode.

Particular aspects of the subject matter described in this disclosure can be implemented to realize one or more of the following potential advantages. In some examples, by utilizing the set of group scheduling parameters and synchronizing the local clock, the described techniques can be used to 1) provide more and richer information about the shipment, location, and conditions, 2) coordinate the asset tracking devices to use less battery power thereof, and 3) coordinate to add or remove one or more asset tracking devices in the group.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

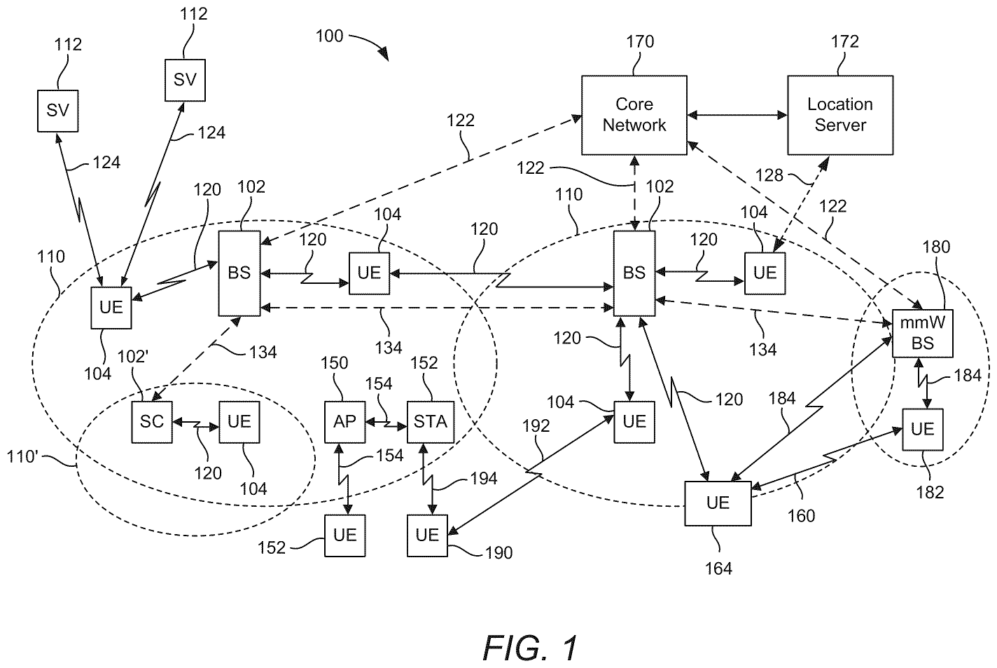

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-cNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHZ unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHz, also referred to as centimeter wave. Communications using the mmW/near mmW radio frequency band have high path loss and a relatively short range.

The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHZ), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect. SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

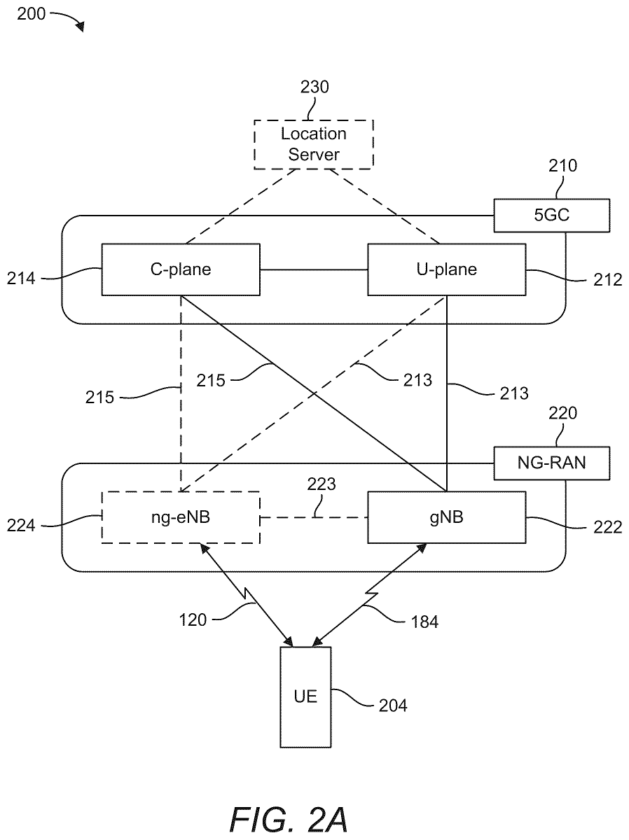

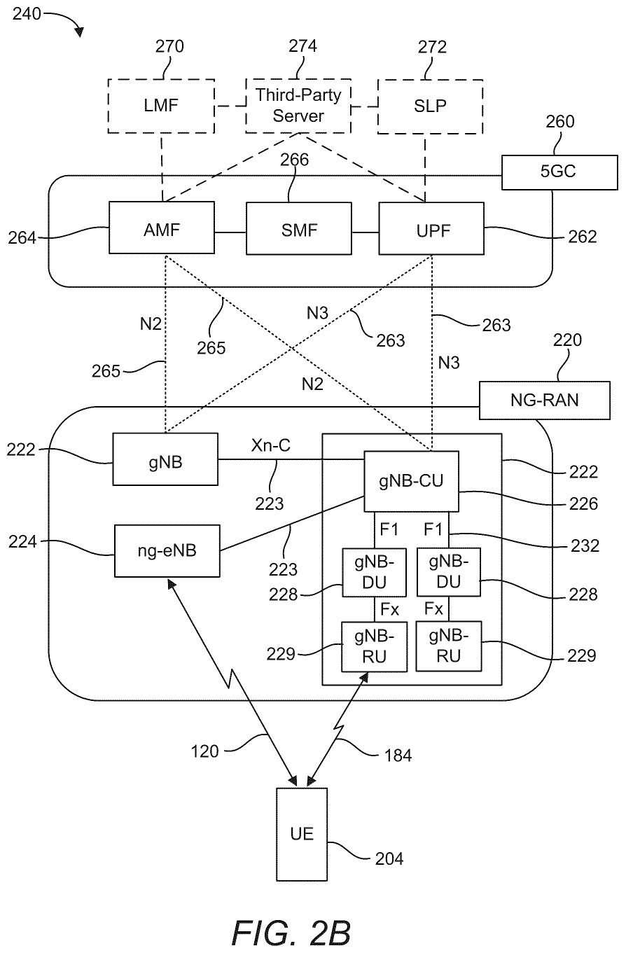

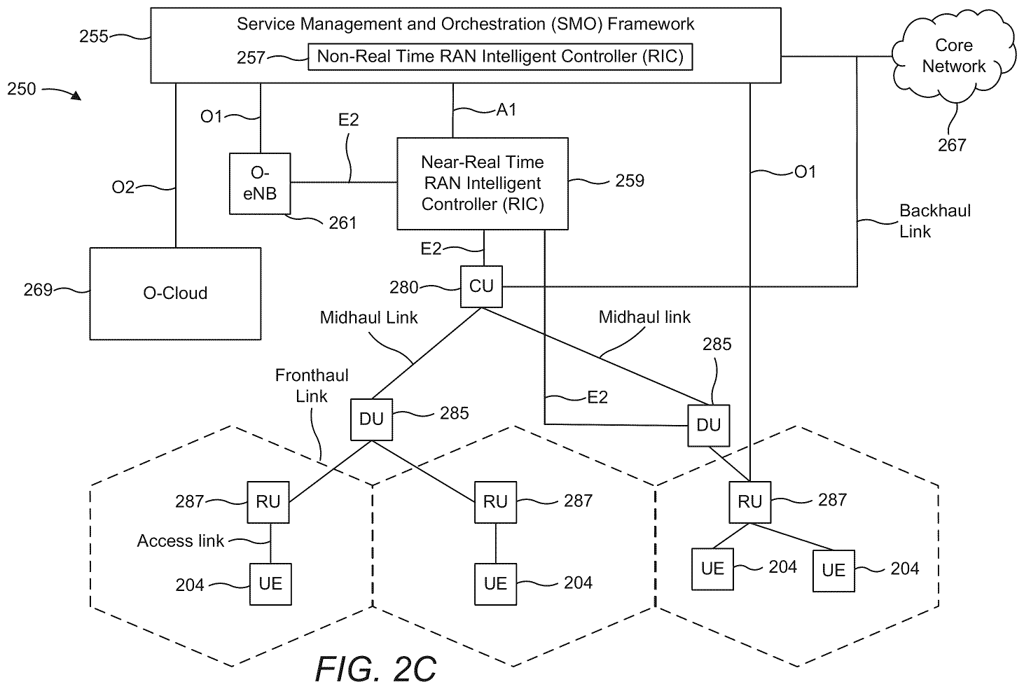

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-cNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUS) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an 02 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-cNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

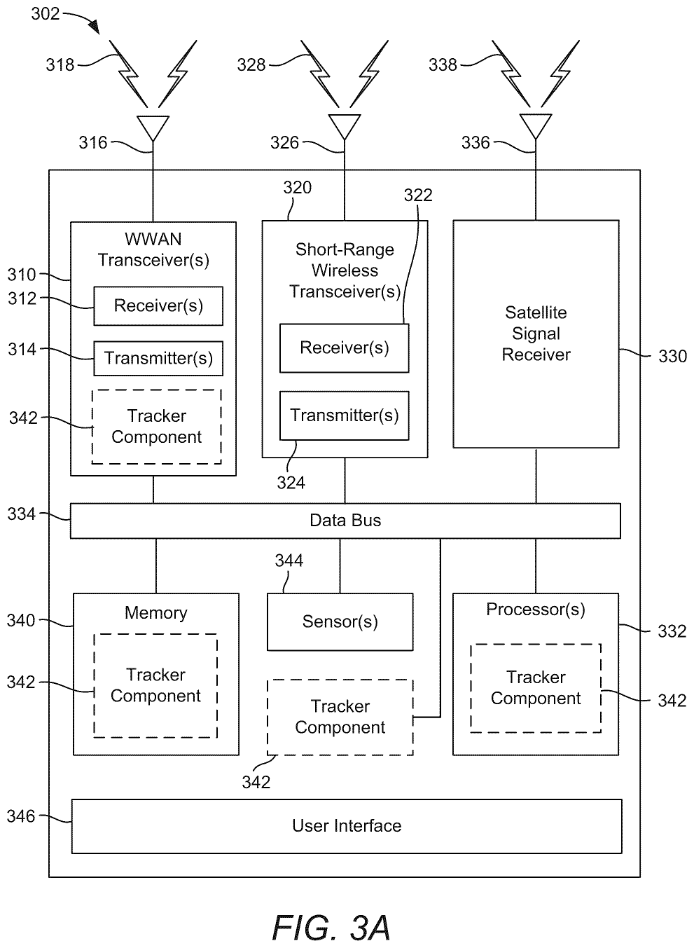

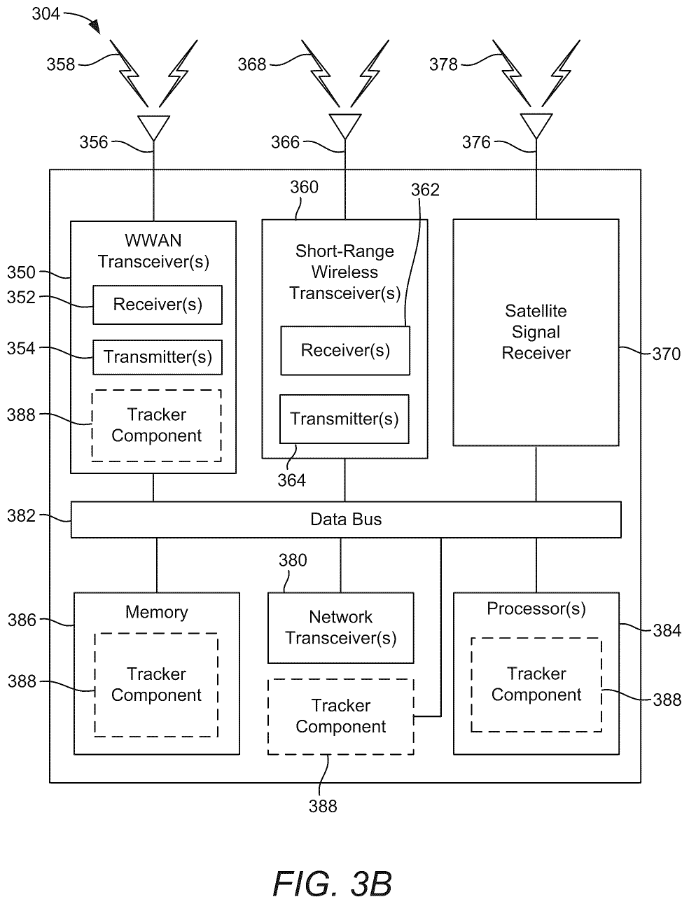

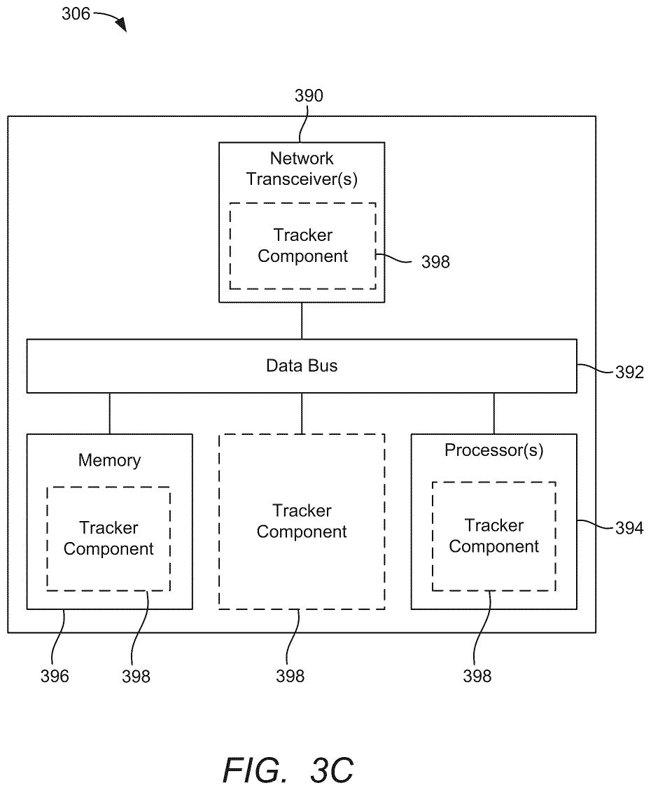

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS®) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include tracker component 342, 388, and 398, respectively. The tracker component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the tracker component 342, 388, and 398 may be external to the processors 332, 384, and 394 (e.g., part of a modem processing system, integrated with another processing system, etc.). Alternatively, the tracker component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the tracker component 342, which may be, for example, part of the one or more WWAN transceivers 310, the memory 340, the one or more processors 332, or any combination thereof, or may be a standalone component. FIG. 3B illustrates possible locations of the tracker component 388, which may be, for example, part of the one or more WWAN transceivers 350, the memory 386, the one or more processors 384, or any combination thereof, or may be a standalone component. FIG. 3C illustrates possible locations of the tracker component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging. RRC connection establishment, RRC connection modification, and

RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the tracker component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

UEs may be classified as RedCap UEs (e.g., asset trackers, wearables, such as smart watches, glasses, rings, etc.) and premium UEs (e.g., smartphones, tablet computers, laptop computers, etc.). RedCap UEs may alternatively be referred to as low-tier UEs, light UEs, or super light UEs. Premium UEs may alternatively be referred to as full-capability UEs or simply UEs. RedCap UEs generally have lower baseband processing capability, fewer antennas (e.g., one receiver antenna as baseline in FR1 or FR2, two receiver antennas optionally), lower operational bandwidth capabilities (e.g., 20 MHz for FR1 with no supplemental uplink or carrier aggregation, or 50 or 100 MHz for FR2), only half duplex frequency division duplex (HD-FDD) capability, smaller HARQ buffer, reduced physical downlink control channel (PDCCH) monitoring, restricted modulation (e.g., 64 QAM for downlink and 16 QAM for uplink), relaxed processing timeline requirements, and/or lower uplink transmission power compared to premium UEs. Different UE tiers can be differentiated by UE category and/or by UE capability. For example, certain types of UEs may be assigned a classification (e.g., by the original equipment manufacturer (OEM), the applicable wireless communications standards, or the like) of “RedCap” and other types of UEs may be assigned a classification of “premium.” Certain tiers of UEs may also report their type (e.g., “RedCap” or “premium”) to the network. Additionally, certain resources and/or channels may be dedicated to certain types of UEs. Accordingly, the UE 302 illustrated in FIG. 3A may represent a “reduced capability” (“RedCap”) UE or a “premium” UE.

Asset tracking, utilizing some or all of the wireless technologies described above, is increasingly being used in logistics-based use cases, such as shipping scenarios. In such scenarios, a small asset tracking device (also referred to as an “asset tracker,” “tracking device,” or simply “tracker”) is attached to an asset being moved along a shipping route. Such tracking devices must maintain battery reserves throughout long journeys and must be selective on how often they wake up to report data to the cloud and which location technology to use for positioning.

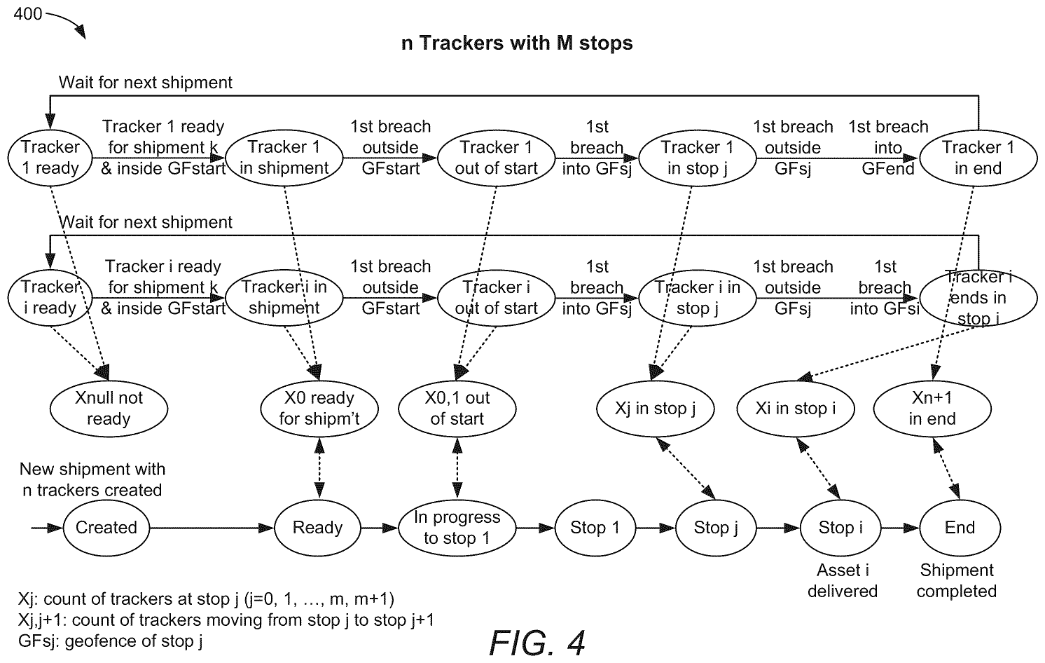

One example of a tracking and sensing use case involves a shipment of a group of assets traveling on the same journey, which may include multiple intermediate waypoints (or stops) where some of the assets will be delivered. This is illustrated in FIG. 4, which is a diagram 400 illustrating an example scenario in which n trackers are transported along a route having m stops (or waypoints), according to aspects of the disclosure. Therefore, a tracker will be utilized for tracking and monitoring every asset individually, while coordinating as a group on the same journey before reaching its own delivery stop. This raises an issue of leveraging the collaborative nature of multiple trackers for improved positioning and monitoring, while conserving battery life of each tracker as much as possible.

The present disclosure proposes coordinated group management techniques and hybrid location/sensing techniques across trackers. In some embodiments, a backend server, communicably coupled to a network (e.g., a cloud), onboards and provisions a group of trackers for a particular shipment. The group of trackers can coordinate among themselves or coordinate with the backend server over the network to track and/or manage the shipment. For instance, the backend server can use the offsets between the trackers to determine the location of the trackers more accurately and reliably. In another example, the backend server can use information from the trackers to monitor the condition or environment of the shipment. In addition to location reporting, the trackers can report data (e.g., data generated from sensors equipped on the trackers, signals captured in the surrounding of the trackers, etc.) to the backend server. The backend server can process the data from the trackers to detect or to infer various situations or conditions of the shipment, such as, for example, the mode of transportation (e.g., being carried by ship, drones, trucks, etc.), road conditions (e.g., traffic jam or traffic accident), extreme weather that may affect the shipment (e.g., heat wave, blizzard, etc.), presence of a potentially malicious tracker traveling with the shipment, etc. Then the backend server may reconfigure the shipment, or cause the carrier of the shipment to take certain actions, to mitigate adverse conditions detected, such as changing the route of the shipment, changing the means of transportation, filtering or blocking signals from a malicious tracker, etc. In addition, or in the alternative, to the aforementioned actions, the backend server can alert the carrier of potential problem detected (e.g., detection of a potentially malicious tracker traveling with the shipment, possible overheating of shipment, etc.).

Communications between the trackers and the backend server can be encrypted to ensure security.

With respect to group coordination, multiple trackers on the same transport can coordinate to (1) provide richer information about the shipment, location, and conditions, (2) use less battery power, and/or (3) add or remove trackers in the group. Thus, when two or more trackers are assigned to a group of assets in the same shipment, they will be “locked” into the same group of trackers. That is, the trackers will be time-synchronized with respect to each other. In order to coordinate and share information across trackers within the same group, the trackers are time synchronized in some implementations. The following algorithm to synchronize and schedule a group of trackers is one example.

Before a shipment starts, n trackers are assigned to n assets in a manifest, which includes a starting stop/waypoint 0, intermediate stops/waypoints 1 to m, and an end stop/waypoint m+1, as shown in FIG. 4. Each tracker i (=1, . . . , n) has a target stop si (≤m) where it is supposed to be delivered with the assigned asset i.

Each tracker i is configured with a global wakeup start time Ti and a time interval Di between two consecutive wakeup times. Every time a tracker wakes up, it executes the following tasks: (1) execute a positioning procedure using one or multiple location technologies, such as global navigation satellite system (GNSS), cell tower scanning, Wi-Fi AP scanning, etc., (2) conduct one or multiple conditional sensing tasks, such as temperature, humidity, accelerometric 3D, gyrometric 3D, barometric air pressure, etc., (3) communicate related information to the backend server, (4) use a global time protocol, such as Network Time Protocol (NTP) (a networking protocol for clock synchronization between computer systems over packet-switched, variable-latency data networks), to obtain a global real-time clock time and synchronize its local clock time to it, and (5) return to sleep mode until the next wakeup time, which is Di after this wake up time.

A set of parameters {(Ti, Di)|i=1, . . . , n} is referred to as a group schedule. While there are many ways to decide a schedule, the following are a few general rules in one example. As a first rule, Di may be the time duration between two consecutive wakeup times for tracker i. The tracker may only be active during a fraction of this time to complete all the activities, which will consume an amount of energy Ei. If the estimated energy budget and the overall time for a shipment is known, then Di can be estimated by: Di=(Shipment Time)*Ei/(Energy Budget). It is recommended to make Di an integer number and a multiple of the smallest possible wakeup interval among all trackers.

As a second rule, Ti: 0≤Ti<Di, is the synchronized (or locked) time of tracker i and it decides the offset of the wakeup time.

As a third rule, for a typical schedule where multiple (denoted “k”) trackers sharing the same wake up duration D, their start time may be evenly distributed by, for example: Ti=i*D/k, for i=1, . . . , k. This will provide k times more location and sensing measurements for the group. If conserving battery life is higher priority than obtaining more measurements, the trackers may choose to increase the wakeup time duration D to k*D, which will maintain a group location/sensing measure cadence of D, while keeping every tracker's power consumption lower by a factor of k.

As a fourth rule, a group schedule can be designed such that all or a subset of the trackers may always wake up at the same time every several wakeup cycles. This helps the backend server to regularly cross-check reports from multiple trackers from the same group at the same time so that confirming a consolidated and more accurate position and/or sensing result. This helps to remove outliers and keep a clean user interface.

As a fifth rule, when a tracker i completes its shipment at its target intermediate stop si, the schedule of remaining trackers may be updated based on the remaining trackers.

For the backend server, it may not only be responsible for user interface, tracker configuration, and group scheduling, but also for processing the location and sensor data measurements reported by all trackers at every wakeup cycle. The fact that a group of trackers are reporting such measurements from the same vehicle or crate of similar condition gives the server extra information to provide better position and condition estimation. The following are a few examples.

As a first example, when at least two trackers locked in the same group wake up at the same time and execute the same scanning of the environment, they might obtain different sets of data. For example, a tracker A may be buried within a box at the middle bottom of a crate, while a tracker B may be on an exposed pallet towards the top or wall of a crate.

The server may aggregate the reported data from both trackers in the same group, which provides more complete information about the trackers' surrounding environment, or “neighborhood.” This may increase the chance for the server to find a better match in its large reference database so that it can obtain a better estimation of the position/condition.

As a second example, when at least two trackers locked in the same group wake up and report results from different location technologies to the server, the server may feed such information to a hybrid location service, which consolidates different information sources, such as neighbor cell towers, Wi-Fi APs, air pressure (for altitude), soft GNSS measurements, etc., and may further feed them into a backend machine learning model to retrieve some insights about the final position and/or condition.

With respect to the preceding two examples, consider the following specific example, in which two or more trackers are configured with a fixed hour and minute to start their wakeup/reporting period, such as at: 00:00, :15:00, :30:00, :45:00 per hour. This schedule may be further adjusted based on the success/failure rate of each tracker's reporting. Each tracker will perform an NTP time synchronization upon each wake cycle so that the trackers' system clocks closely track real time. Each tracker then reports its measurements at nearly the same time, allowing a comparison of the results and an opportunity to select the more precise location fix to represent the trackers' location. This also helps to obtain a better performance evaluation of different location technologies executed at the same time and at the same location. Furthermore, the reported network scan data from each tracker can be combined to help the location server obtain a more comprehensive database search to determine a better location fix.

As a third example, when at least two trackers locked in the same group wake up and report at different times, they may be configured to execute alternate location technologies. As a result, the server gets a mixture of location scans/reports on consecutive points along the same route. This will provide a more robust and seamless positioning service to the user. For example, when traveling through a tunnel or urban downtown area, a tracker reporting GNSS measurements may fail in one wakeup period, while another tracker reporting Wi-Fi AP may provide very good data for the server to obtain a fine position in the next wakeup period. All this may be done on the server side without making any dynamic change on the tracker device itself.

As a specific example of this third example, three trackers, denoted A, B, and C, may be configured with a choreographed and alternating locked (time-synchronized) schedule. Tracker A may be configured to wake up and report every: 00:00, :15:00, :30:00, and :45:00 per hour. Tracker B may be configured to wake up and report every :05:00, :20:00, :35:00, and :50:00 per hour. Tracker C may be configured to wake up and report every :10:00, :25:00, :40:00, and :55:00 per hour. Optionally, the three trackers may be configured to alternate location technologies to obtain a mix of location reports (this is useful if, along the route, certain location technology types are more likely to succeed or fail, or certain trackers execute certain location technologies better than others). Such a reporting schedule provides more incremental route locations, as there are three times more reports, without additional battery burn per tracker. Alternatively, the reporting period may be extended per tracker to be three times longer per tracker, which results in the same number of reports but uses less power by each tracker, thereby extending the battery life of each tracker.

In an aspect, the trackers' battery levels can be taken into consideration with respect to group coordination. For example, for a group of time locked trackers, the backend server or peer-to-peer (P2P)-linked trackers can agree on which tracker(s) report(s) location based on current battery levels. For example, the tracker with the highest battery level may report more location measurements, while trackers with lower battery levels may report fewer location measurements, but in a synchronized way so that the overall reporting to the backend server is still at the expected interval or at an acceptable interval.

As a specific example, a first tracker, denoted A, may have a battery level of 50%, and a second tracker, denoted B, may have a battery level of 80%. In this case, tracker A may report location measurements, as tracker A's end shipment completion time is in 4 hours and its estimated battery level at arrival is 45%. In contrast, tracker B's shipment completion time is in four days, and its estimated battery level at arrival is 15%.

With respect to P2P coordination in a group, within the same group of locked trackers, various P2P technologies can be used to estimate the relative distance and condition between trackers locally. For example, Wi-Fi received signal strength indication (RSSI) and/or round-trip-time (RTT), BLUETOOTH LOW ENERGY® (BLE) beacon, angle-of-arrival (AoA), and/or angle-of-departure (AoD), and/or sonar ping can be used for short-range distance estimation. An inertial measurement unit (IMU) or other motion sensors, gyroscope, compass, historical direction, knowledge of the route from a map service, or other techniques can be used to adjust the relative position between two or more trackers on the same route, and/or to adjust the location reported to the cloud to obtain a more precise individual location per tracker.

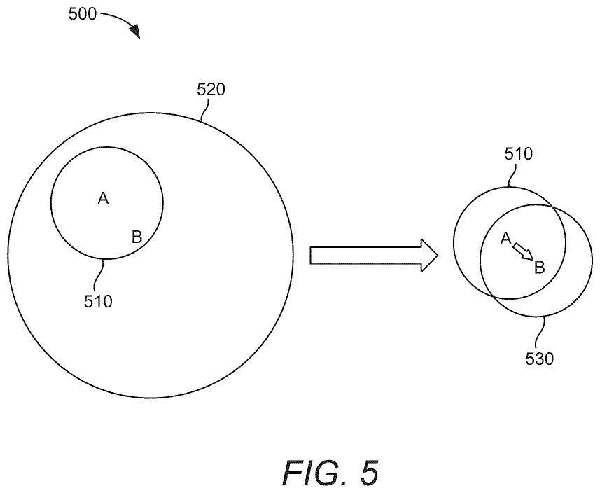

FIG. 5 is a diagram 500 illustrating an example scenario in which the additional P2P information between trackers A and B helps to derive a better position result for tracker B, according to aspects of the disclosure. In the example of FIG. 5, two trackers on a truck together, denoted A and B, may be configured to report their position measurements and their relative P2P measurements to a backend server (e.g., LMF 270). When it is tracker A's turn to report, it reports a first location having a location uncertainty area 510. Tracker B either does not report or does report (per time lock schedule) but reports a less precise location (having a location uncertainty area 520) than the location reported by tracker A. Tracker A includes its bearing with the location it reports, and also includes a computed estimate of the distance and orientation from tracker B. This allows the backend server to adjust tracker B's center of uncertainty from that of tracker A, resulting in a location uncertainty area 530 for tracker B. Alternatively, tracker B may choose to not report its location, and instead just use tracker A's location as a reference, compensated by its local relative positioning to tracker A. Further, on the server side, because of the greater accuracy, the position information derived from tracker A's reported data may provide a far more trustworthy result than that from tracker B.

With respect to updating the group of trackers, the backend server can utilize its knowledge of shipments and waypoints, such as a planned delivery at an intermediate stop, known traffic interchanges (e.g., major interstate exits, airports, distribution centers, or explicit shipment details) to schedule a tracker's detachment from the locked group. Detached trackers may still be in the same trailer/crate/truck/etc. but may report independently from the group as a potential or planned split from the other trackers is imminent. The concept is to have the tracker return to its own independent reporting schedule ahead of arriving at a destination (e.g., a distribution center) so that once it splits from the other trackers, it does not miss any detail that the backend server desires. The detachment can also be confirmed based on historical location data in the cloud.

Even without knowledge of a planned journey/delivery schedule, the backend server may automatically detect and lock multiple trackers that have been moving on the same route, and detect a diverted/missing tracker or a newly joined tracker.

Alerts may be raised for various cases, such as (1) when a tracker never reaches its planned delivery stop while other trackers in the group have passed that stop, (2) when a tracker still goes with the rest of the group after its planned delivery stop, (3) when a tracker goes out of the range of the rest of the group, and/or (4) when a tracker stops reporting at its assigned schedule while the rest of the group still does so.

On the other hand, a new tracker may be attached to the current group when a new asset with the new tracker is added to the shipment. Even without knowledge of a planned journey/delivery schedule, the system may automatically detect and lock multiple trackers that have been moving along the same route. There are various signals and information that can be leveraged to determine that a tracker is with the rest of the group. For example, pattern matches of sensor shock events, temperature changes, light exposures, humidity levels, noise detections, and/or amplitudes (e.g., for the truck hitting a pothole, if the shock sensor events match, it can be inferred that the trackers are on the same truck) could all be used to infer that the trackers are on the same truck.

As other examples, it may be determined that a tracker belongs to a particular group by detection of the same geofence breach, a per shipment manifest, the trackers following the same route, having the same relative distance from each other, and the same speed over time. Trackers may also be determined to belong to the same group based on detection of the same APs, BLUETOOTH identifiers, cell identifiers, etc., and/or detection of each other.

The present disclosure further provides techniques for detecting external trackers in the vicinity using a group of authentic trackers. An external tracker refers to a tracker that does not belong to the group of authentic trackers. In other words, the external tracker belongs to an ecosystem different from the ecosystem(s) of the group of authentic trackers. These techniques may generally help to identify an external tracker in the vicinity that belongs to an ecosystem that is different from that of authentic trackers. The external tracker may not necessarily be spurious or malicious. It may simply be part of another ecosystem that is also providing tracking services. Hence, information exchanged between the two ecosystems can facilitate enhanced positioning accuracy and help raise alerts, such as “lost tracker found” and the like.

Further, when a group of authentic trackers all detect the presence of a particular external tracker, the backend server may infer that those authentic trackers are collocated within a certain region. Note that each of the authentic trackers may independently detect the presence of the external tracker.

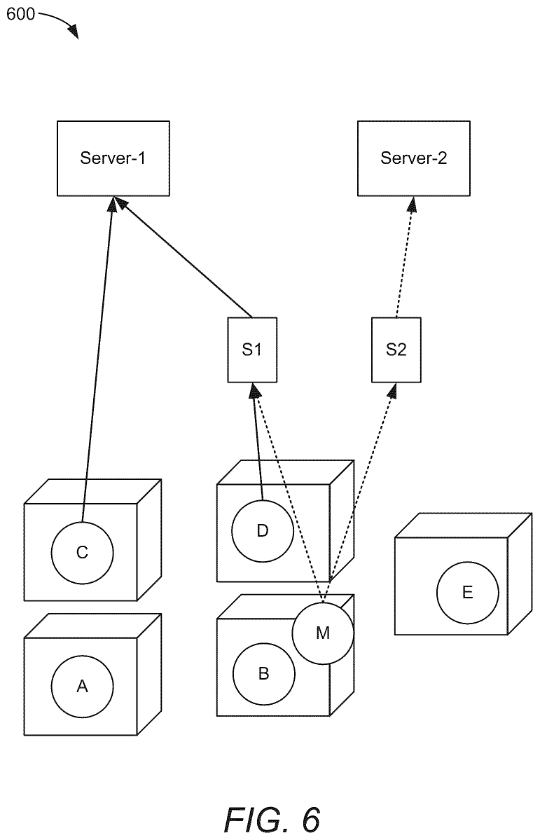

FIG. 6 is a diagram 600 illustrating an example technique for detecting external trackers using manufacturing/vendor-specific information, according to aspects of the disclosure. Consider a group of packages/assets being transported in a truck, or through a warehouse, or the like. These assets may be associated with authentic trackers (denoted A to E) that are part of a common ecosystem and may employ a preconfigured protocol. Let there also be a spurious/malicious external tracker M that intends to locate/track this group of assets.

The trackers' measurements may be reported to a remote server directly, or via a smartphone or other relay device S1 in the vicinity (but also part of the same ecosystem). Note that tracker M's measurement may also be relayed towards the owner of tracker M, possibly via another relay device S2.

In the present technique, it is assumed that relay device S1 can forward tracker M's beacon transmission to the Server-1. Since tracker M may be from another manufacturer or vendor, any payload information cannot be decoded, but its header information may be forwarded to Server-1. Each manufacturer/vendor may be associated with a unique set of identifier bits in the header. Thus, Server-1 may first detect that tracker M belongs to another ecosystem of trackers, based on header information in tracker M's transmission. When the external tracker M is detected (at Server-1) to be moving along with the group of authentic trackers A to E, for a certain threshold period of time, an alert may be raised by Server-1.

This detection of an external tracker M may be performed in the following way. A relay device S1 in the vicinity detects the received signal strength (or SNR) corresponding to trackers A to E and M to be within some threshold value of one another. As an extension, more than one device may detect such a case. The authentic trackers A to E scan the vicinity for the potential presence of an external tracker. This scanning is described further below.

There may be cases wherein false alerts are generated, such as in a crowded area, public transport, etc. Hence, the above detection may be performed when the number of trackers in the vicinity does not exceed a certain threshold number. For example, consider a van transporting a large number of goods equipped with such trackers. A list of known trackers may be stored/preconfigured and ignored while searching for external trackers. This list may vary as per the specific shipment of which trackers A to E are a part.

Identifiers of the trackers may also or alternatively be used to detect external trackers. With continued reference to FIG. 6, for this technique, it is assumed that Server-1 and Server-2 have an agreement/contract to exchange detected tag information for the purpose of security. Alternatively, relay device S1 may be able to decode and forward tracker M's transmissions to Server-1. Authentic beacon transmissions may contain an identifier that is drawn from a preconfigured set of identifiers that is also known at the server. Hence, tracker M's transmission can be detected, as it would not be aware of the authentic identifiers. The identifiers may be the output of an “open” encryption methodology, such as AES-128/256 (which involves outputting a cyphertext using a preconfigured set of plaintexts). The server would then decrypt the message and compare the received plaintext with the known set of valid identifiers.

Since tracker M could passively listen to the authentic transmissions and simply retransmit the same identifier(s), an additional enhancement may involve an authentic tracker transmitting a unique identifier in each beacon (or for some number of beacons, before cycling back to the same identifiers). To reduce overhead and prevent exploding the size of the dataset of valid identifiers, a preconfigured pseudo-random pattern may be utilized in conjunction with a given plaintext. In this case, as a first step, a tracker may first randomly select a plaintext (denoted P1) for encryption. Second, this plaintext may map to a set of allowed pseudo-random patterns, each associated with a pattern ID. The tracker may proceed to again randomly select a pattern. Third, using the selected pseudo-random pattern, P1 is modified to generate a unique plaintext “P2.” P2 is appended with the pattern ID (either at the beginning or the end) and then encrypted to generate the ciphertext (essentially the identifier) that is finally transmitted in the beacon. Note that each beacon transmission is associated with a unique P2 and hence a unique identifier. Fourth, on the server side, for each received beacon message, the server decrypts the message to recover the corresponding P2. The first (or last) number of bits may represent the pattern ID, using which P1 is recovered. Fifth, if P1 is not seen to be in the set of valid identifiers, but a set of other valid identifiers are seen in the same vicinity, then the corresponding tracker is flagged as malicious. Note that a group of trackers may be detected to be in the “same vicinity” if the first hop's (denoted “S”) IP or MAC address is common to all of them or the locations of the first hop devices are within a threshold region.

There are a number of ways in which a pseudo-random pattern is used to generate P2 from P1 (and vice-versa). The pattern may comprise a set of bitmaps, each indicating which of the bits in P1 must be inverted (i.e., 0 to 1 and 1 to 0). The pattern may comprise a sequence (of arbitrary length) of random binary values, that are each bitwise exclusive OR'ed with P1 sequentially. Alternatively, the pattern may represent a sequence (of arbitrary length) of random binary values, that are added/subtracted/multiplied to P1 sequentially. The above sequences may also comprise a starting value, along with a fixed incremental offset.

Yet another scenario can occur when tracker M is actually an authentic asset that has been compromised. In other words, an authentic tracker may be hacked (through a Trojan virus, for instance) and controlled by a malicious entity. Hence, tracker M may become a part of the network of authentic trackers and may also potentially seek to gather information from the other authentic trackers. Note that tracker M is truly a malicious tracker when it also transmits beacons within another ecosystem in order to reach its owner (otherwise, the “authentic” transmissions would continue to reach Server-1, which is harmless). As such, the first technique described with reference to FIG. 6 is still applicable here.

However, tracker M may still act maliciously by embedding relevant information in the beacon (within Server-1's ecosystem) that may be received and relayed by relay device S2 to Server-2. Accordingly, the additional following irregularities may be monitored and detected (either by relay device S1 or Server-1): periodicity, transmit power, information element format, and prior trajectory. With respect to periodicity, tracker M may transmit beacons more/less often as an attempt to make itself identifiable to relay device S2. With respect to transmit power, tracker M may transmit beacons with a certain transmit power pattern, to make itself identifiable to relay device S2. With respect to information element (IE) format, tracker M may include additional bit information that does not abide by the format defined under Server-1's ecosystem. The order of the IEs should abide by the expected format as well. With respect to prior trajectory, tracker M may be a compromised asset tracker that is first compromised and then attached to the inventory that it seeks to track. Hence, the trajectory of tracker M prior to it entering the vicinity of trackers A to E may also be used to carefully monitor and flag for manual inspection. Furthermore, in this case, tracker M's identifier may not be match with a list of identifiers that is specific to a set of inventory.

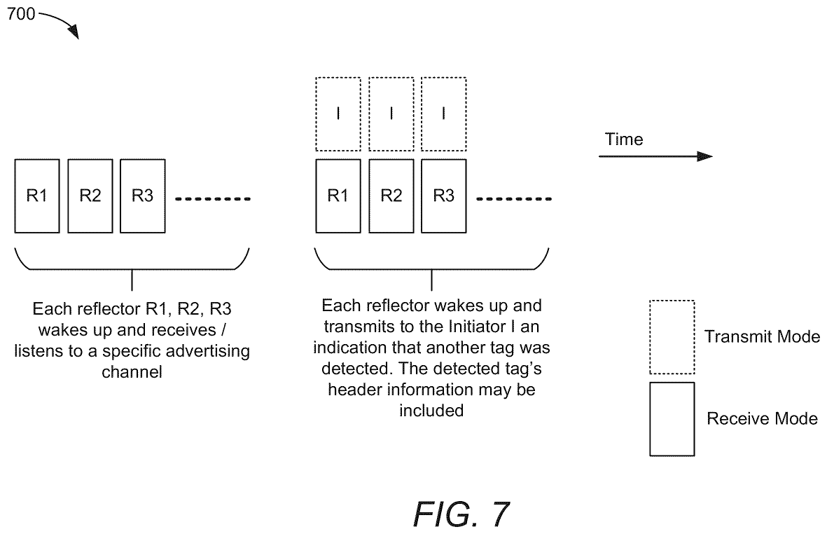

FIG. 7 is a diagram 700 illustrating an example technique for detecting external trackers using the authentic trackers themselves, according to aspects of the disclosure. In this case, the trackers themselves may also scan the vicinity. However, this can be power-intensive. Given a group of trackers, it may be performed in a less power-intensive way by appropriate scheduling. In the example of FIG. 7, the group of trackers is employing BLE. The group of authentic trackers may synchronize and use a dedicated channel sounding (CS) procedure for scanning for (spurious) transmissions from tracker M. The coordinating tracker, or initiator, may be a superior tracker. Note that each pair of devices may have their own CS procedure (which are non-overlapping). The listen/receive mode operation for each of the authentic trackers (also denoted “tags”) may be multiplexed over the time slots (or CS steps), as well as frequency (over the advertising channels). This conserves power and ensures efficient scanning. In a subsequent CS event, each of the trackers may inform the initiator device.

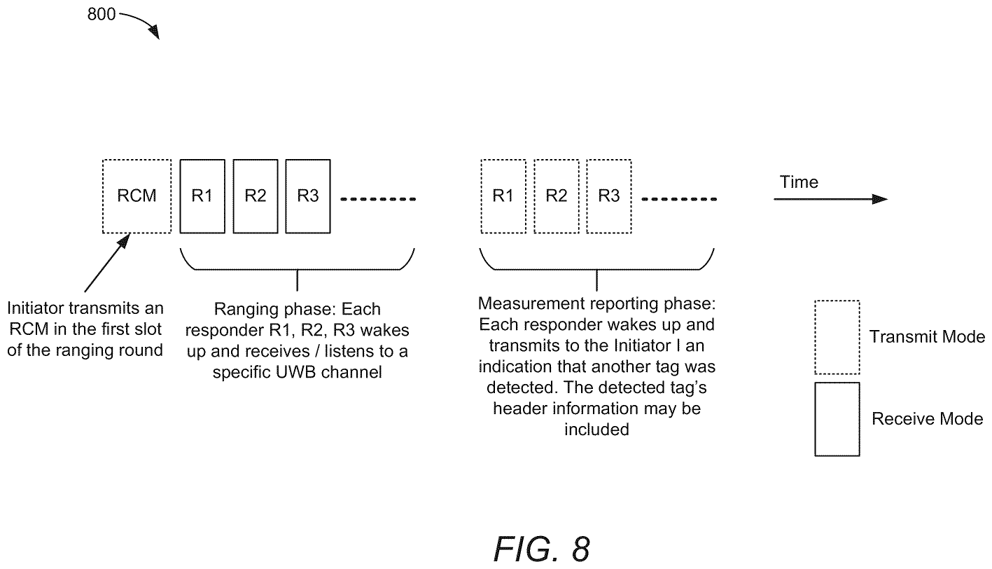

FIG. 8 is a diagram 800 illustrating an example technique for detecting external trackers using the authentic trackers themselves, according to aspects of the disclosure. In the example of FIG. 8, the group of trackers is employing ultra-wideband (UWB). In this case, the initiator device can configure a dedicated ranging round for scanning for (spurious) transmissions. The authentic trackers may be multiplexed over the ranging slots, as well as frequency (such as channels 5 and 9). This conserves power. Note that in this case, multiple responders may be part of the same UWB ranging session (for a given channel). These measurements may also be reported to a remote server directly, or via a smartphone in the vicinity (but also part of the same ecosystem).

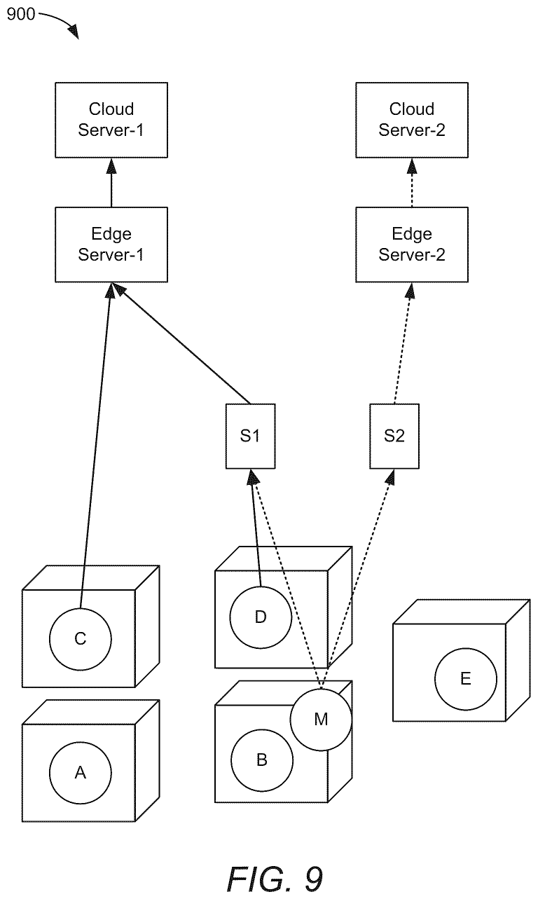

FIG. 9 is a diagram 900 illustrating example signaling aspects for cross-vendor external tracker detection, according to aspects of the disclosure. Cross-vendor external tracker detection would need to utilize interaction between servers (e.g., Cloud-Server-1 and Cloud-Server-2), and potentially other nodes of the architecture as well. A contract/agreement may also be needed between the two organizations to exchange tracker identity information without compromising privacy, for the purpose of enabling the detection of external asset tracking across vendors/ecosystems. This type of exchange may occur at the level of the cloud servers, where a secure link can be maintained, albeit introducing higher latency. Alternatively, other nodes, such as edge servers (Edge-Server-1 and Edge-Server-2) or even relay nodes, such as the relay devices S1 and S2, may be allowed to access information across ecosystems. This will enable much faster detection with lower latency.

For instance, relay device S1 may detect the presence of tracker M and request its tracker information. This information may indicate (1) whether the tracker is being used by a regular consumer or for inventory tracking by another organization (relevant to whether the other organization is permitted to employ trackers in the same vicinity), (2) whether it has been reported as lost, and/or (3) its last known location and/or trajectory. If deemed to be a spurious tracker, an alert may be raised by Cloud/Edge-Server-1 to Cloud/Edge-Server-2 regarding the potential misuse.

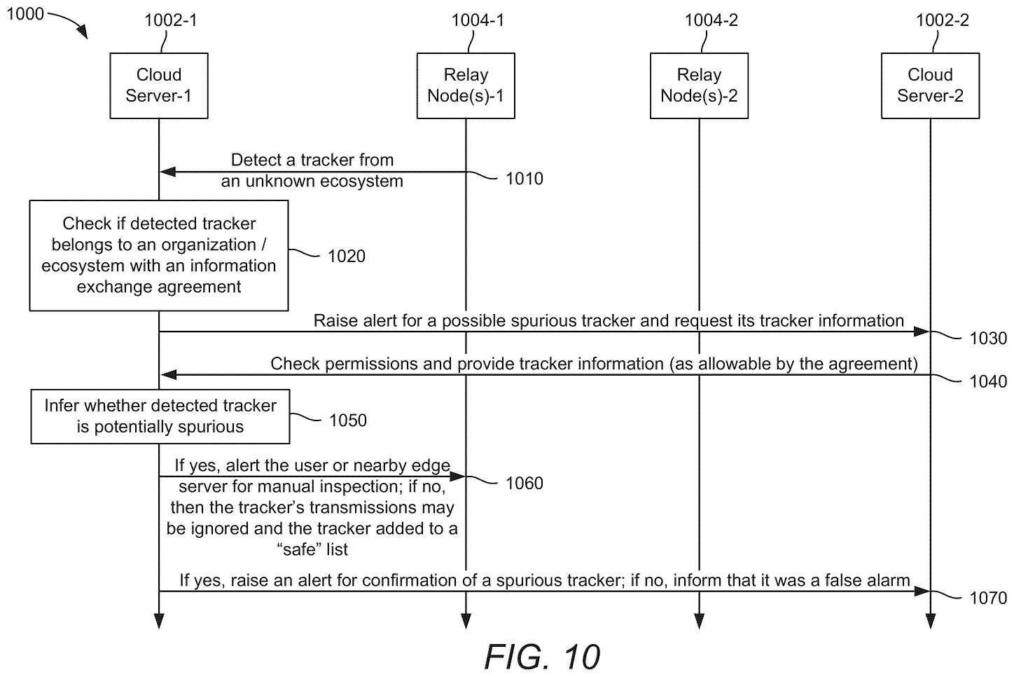

FIG. 10 is a diagram 1000 illustrating an example messaging flow for cross-vendor external tracker detection, according to aspects of the disclosure. This message flow considers interactions at the cloud-server level. In the example of FIG. 10, a relay node may either comprise an edge server or a smart device (consumer level) that is able to directly interact with the cloud server. The tracker information refers to the tracker information defined above.

In the example of FIG. 10, there are two ecosystems, each including a cloud server and one or more relay nodes. Specifically, the first ecosystem includes a first cloud server 1002-1 (labeled “Cloud Server-1”) and one or more first relay nodes 1004-1 (labeled “Relay Node(s)-1”). The second ecosystem includes a second cloud server 1002-2 (labeled “Cloud Server-2”) and one or more second relay nodes 1004-2 (labeled “Relay Node(s)-2”).

At stage 1010, at least one of the one or more first relay nodes 1004-1 detects a tracker from another (unknown) ecosystem and notifies the first cloud server 1002-1. At stage 1020, the first cloud server 1002-1 checks to determine whether the detected tracker belongs to an organization or ecosystem with which the first cloud server 1002-1 has an information exchange agreement (here, the second ecosystem). In the example of FIG. 10, the first cloud server 1002-1 determines that the detected tracker may belong to the second ecosystem. Accordingly, at stage 1030, the first cloud server 1002-1 sends a message to the second cloud server 1002-2 raising an alert for a possibly spurious tracker. The message also includes a request for the tracker information of the detected tracker. In response, at stage 1040, the second cloud server 1002-2 checks the applicable permissions and provides the requested tracker information (as allowable by the agreement).

At stage 1050, the first cloud server 1002-1 infers whether the detected tracker is potentially spurious based on the information received from the second cloud server 1002-2. At stage 1060, if the detected tracker is potentially spurious, the cloud server 1002-1 alerts a user or a nearby edge server for manual inspection. If the detected tracker is not spurious, then the tracker's transmissions may be ignored and the tracker may be added to a “safe” list. At stage 1070, if the detected tracker is potentially spurious, the cloud server 1002-1 sends a message to the second cloud server 1002-2 raising an alert for confirmation of a spurious tracker. If the detected tracker is not spurious, then the first cloud server 1002-1 informs the second cloud server 1002-2 that it was a false alarm.

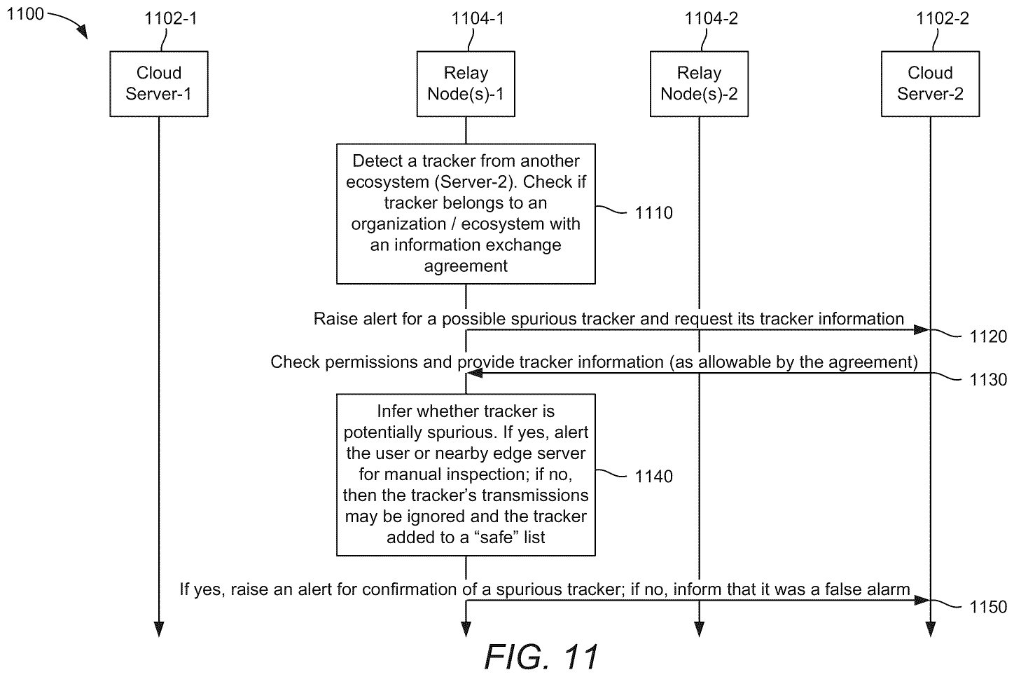

FIG. 11 is a diagram 1100 illustrating another example messaging flow for cross-vendor external tracker detection, according to aspects of the disclosure. This message flow considers interactions directly between relay nodes and cloud servers of different ecosystems/organizations. In the example of FIG. 11, a relay node may either comprise an edge server or a smart device (consumer level) that is able to directly interact with the cloud server. The tracker information refers to the tracker information defined above.

In the example of FIG. 11, there are two ecosystems, each including a cloud server and one or more relay nodes. Specifically, the first ecosystem includes a first cloud server 1102-1 (labeled “Cloud Server-1”) and one or more first relay nodes 1104-1 (labeled “Relay Node(s)-1”). The second ecosystem includes a second cloud server 1102-2 (labeled “Cloud Server-2”) and one or more second relay nodes 1104-2 (labeled “Relay Node(s)-2”).

At stage 1110, at least one of the one or more first relay nodes 1004-1 detects a tracker from another (unknown) ecosystem and checks to determine whether the detected tracker belongs to an organization or ecosystem with which the at least one relay node 1104-1 has an information exchange agreement (here, the second ecosystem). In the example of FIG. 11, the at least one relay node 1104-1 determines that the detected tracker may belong to the second ecosystem. Accordingly, at stage 1120, the at least one relay node 1104-1 sends a message to the second cloud server 1102-2 raising an alert for a possibly spurious tracker. The message also includes a request for the tracker information of the detected tracker. In response, at stage 1130, the second cloud server 1002-2 checks the applicable permissions and provides the requested tracker information (as allowable by the agreement).

At stage 1140, the at least one relay node 1104-1 infers whether the detected tracker is potentially spurious based on the information received from the second cloud server 1102-2. If the detected tracker is potentially spurious, the at least one relay node 1104-1 alerts a user or a nearby edge server for manual inspection. If the detected tracker is not spurious, then the tracker's transmissions may be ignored and the tracker may be added to a “safe” list. At stage 1150, if the detected tracker is potentially spurious, the at least one relay node 1104-1 sends a message to the second cloud server 1002-2 raising an alert for confirmation of a spurious tracker. If the detected tracker is not spurious, then the at least one relay node 1104-1 informs the second cloud server 1002-2 that it was a false alarm.

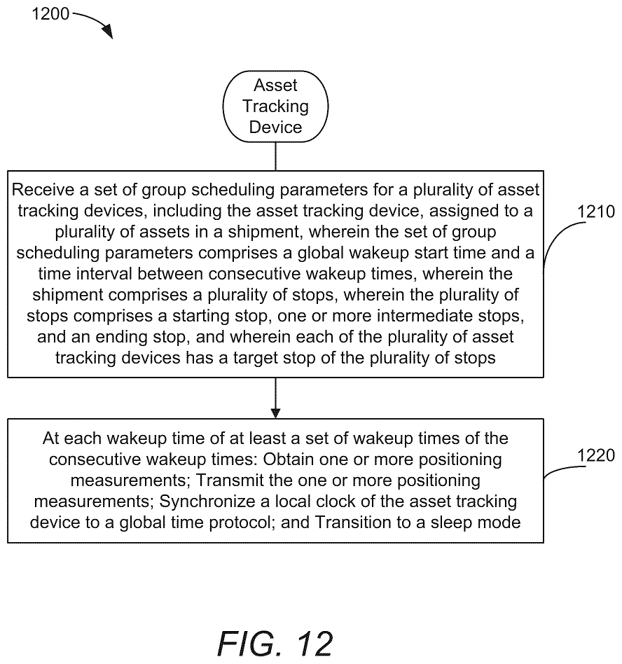

FIG. 12 illustrates an example method 1200 of wireless communication, according to aspects of the disclosure. In an aspect, method 1200 may be performed by an asset tracking device (e.g., any of the tracking devices described herein).

At 1210, the asset tracking device receives a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops. In an aspect, operation 1210 may be performed by the one or more WWAN transceivers 310, the one or more short-range wireless transceivers 320, the one or more processors 342, memory 340, and/or tracker component 348, any or all of which may be considered means for performing this operation.

At 1220, at each wakeup time of at least a set of wakeup times of the consecutive wakeup times, the asset tracking device obtains one or more positioning measurements, transmits the one or more positioning measurements, synchronizes a local clock of the asset tracking device to a global time protocol, and transitions to a sleep mode. In an aspect, operation 1220 may be performed by the one or more WWAN transceivers 310, the one or more short-range wireless transceivers 320, the one or more processors 342, memory 340, and/or tracker component 348, any or all of which may be considered means for performing this operation.

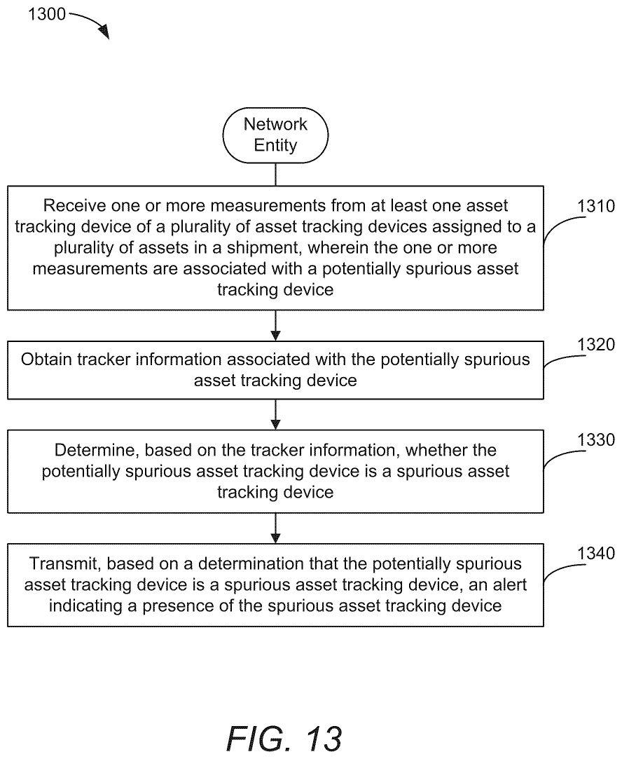

FIG. 13 illustrates an example method 1300 of communication, according to aspects of the disclosure. In an aspect, method 1300 may be performed by a network entity (e.g., any of the cloud servers described herein or any of the relay nodes described herein).

At 1310, the network entity receives one or more measurements from at least one asset tracking device of a plurality of asset tracking devices assigned to a plurality of assets in a shipment, wherein the one or more measurements are associated with a potentially spurious asset tracking device. In an aspect, operation 1310 may be performed by the one or more WWAN transceivers 350, the one or more short-range wireless transceivers 360, the one or more processors 384, memory 386, and/or tracker component 388, any or all of which may be considered means for performing this operation. In an aspect, operation 1310 may be performed by the one or more network transceivers 390, the one or more processors 394, memory 396, and/or tracker component 398, any or all of which may be considered means for performing this operation.

At 1320, the network entity obtains tracker information associated with the potentially spurious asset tracking device. In an aspect, operation 1320 may be performed by the one or more WWAN transceivers 350, the one or more short-range wireless transceivers 360, the one or more processors 384, memory 386, and/or tracker component 388, any or all of which may be considered means for performing this operation. In an aspect, operation 1320 may be performed by the one or more network transceivers 390, the one or more processors 394, memory 396, and/or tracker component 398, any or all of which may be considered means for performing this operation.

At 1330, the network entity determines, based on the tracker information, whether the potentially spurious asset tracking device is a spurious asset tracking device. In an aspect, operation 1330 may be performed by the one or more WWAN transceivers 350, the one or more short-range wireless transceivers 360, the one or more processors 384, memory 386, and/or tracker component 388, any or all of which may be considered means for performing this operation. In an aspect, operation 1330 may be performed by the one or more network transceivers 390, the one or more processors 394, memory 396, and/or tracker component 398, any or all of which may be considered means for performing this operation.

At 1340, the network entity transmits, based on a determination that the potentially spurious asset tracking device is a spurious asset tracking device, an alert indicating a presence of the spurious asset tracking device. In an aspect, operation 1340 may be performed by the one or more WWAN transceivers 350, the one or more short-range wireless transceivers 360, the one or more processors 384, memory 386, and/or tracker component 388, any or all of which may be considered means for performing this operation. In an aspect, operation 1340 may be performed by the one or more network transceivers 390, the one or more processors 394, memory 396, and/or tracker component 398, any or all of which may be considered means for performing this operation.

As will be appreciated, technical advantages of the methods 1200 and 1300 include that they 1) provide more and richer information about the shipment, location, and conditions, 2) coordinate the asset tracking devices to use less battery power thereof, and 3) coordinate to add or remove one or more asset tracking devices in the group.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by an asset tracking device, comprising: receiving a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtaining one or more positioning measurements; transmitting the one or more positioning measurements; synchronizing a local clock of the asset tracking device to a global time protocol; and transitioning to a sleep mode.

Clause 2. The method of clause 1, wherein the time interval is a smallest time interval between consecutive wakeup times supported by the plurality of asset tracking devices.

Clause 3. The method of any of clauses 1 to 2, wherein: a first subset of the plurality of asset tracking devices is configured to wake up every N wakeup times of the consecutive wakeup times, and N is greater than or equal to 1.

Clause 4. The method of clause 3, wherein: a second subset of the plurality of asset tracking devices is configured to wake up every M wakeup times of the consecutive wakeup times, and M is greater than or equal to 1.

Clause 5. The method of clause 4, wherein: the first subset of the plurality of asset tracking devices is configured to report a first type of positioning measurements, and the second subset of the plurality of asset tracking devices is configured to report a second type of positioning measurements different than the first type of positioning measurements.

Clause 6. The method of any of clauses 1 to 5, wherein: the set of wakeup times comprises every N wakeup times of the consecutive wakeup times until the target stop of the asset tracking device, where N is greater than 1, or the set of wakeup times comprises all wakeup times of the consecutive wakeup times until the target stop of the asset tracking device.

Clause 7. The method of any of clauses 1 to 6, further comprising, at each wakeup time of at least the set of wakeup times of the consecutive wakeup times: obtaining one or more sensor measurements from one or more sensors of the asset tracking device; and transmitting the one or more sensor measurements.

Clause 8. The method of clause 7, wherein obtaining the one or more sensor measurements comprises: obtaining one or more temperature measurements from one or more temperature sensors of the asset tracking device; obtaining one or more humidity measurements from one or more humidity sensors of the asset tracking device; obtaining one or more accelerometer measurements from one or more accelerometers of the asset tracking device; obtaining one or more gyrometric measurements from one or more gyroscopic sensors of the asset tracking device; obtaining one or more barometric measurements from one or more barometric sensors of the asset tracking device; obtaining one or more light measurements from one or more light sensors of the asset tracking device; obtaining one or more noise measurements from one or more microphones of the asset tracking device; or any combination thereof.

Clause 9. The method of any of clauses 1 to 8, wherein obtaining the one or more positioning measurements comprises: obtaining one or more global navigation satellite system (GNSS) measurements; obtaining one or more measurements of one or more cellular base stations; obtaining one or more measurements of one or more wireless local area network (WLAN) access points; obtaining one or more measurements of one or more BLUETOOTH® beacons; or any combination thereof.

Clause 10. The method of any of clauses 1 to 9, further comprising: transmitting, based on a location of the asset tracking device being within a threshold distance of the target stop of the asset tracking device, positioning measurements independently of the group scheduling parameters.

Clause 11. The method of any of clauses 1 to 10, further comprising triggering an alert in response to: the asset tracking device not reaching the target stop of the asset tracking device while remaining asset tracking devices of the plurality of asset tracking devices have passed the target stop of the asset tracking device, the asset tracking device continuing on the shipment after the target stop of the asset tracking device, a location of the asset tracking device being at a distance greater than a threshold distance from locations of remaining asset tracking devices of the plurality of asset tracking devices, or the asset tracking device ceasing to transmit at each wakeup time of at least the set of wakeup times of the consecutive wakeup times while remaining asset tracking devices of the plurality of asset tracking devices transmit at each wakeup time of at least the set of wakeup times of the consecutive wakeup times.

Clause 12. The method of any of clauses 1 to 11, wherein the asset tracking device is added to the plurality of asset tracking devices based on the asset tracking device being on the shipment for greater than a threshold period of time.

Clause 13. The method of clause 12, wherein the asset tracking device is determined to be on the shipment based on pattern matches between measurements reported by the asset tracking device and measurements reported by remaining asset tracking devices of the plurality of asset tracking devices of: sensor shock events, temperature changes, light exposures, humidity levels, noise detections, amplitude changes, or any combination thereof.

Clause 14. The method of any of clauses 12 to 13, wherein the asset tracking device is determined to be on the shipment based on: a breach of a geofence breached by the remaining asset tracking devices, a manifest of the shipment, a route, a speed, or both of the asset tracking device matching a route, a speed, or both of the remaining asset tracking devices for at least the threshold period of time, a relative distance between the asset tracking device and the remaining asset tracking devices being less than a threshold for at least the threshold period of time, detection by the asset tracking device and the remaining asset tracking devices of the same cellular base stations, BLUETOOTH® beacons, Wi-Fi access points, or any combination thereof, detection by the asset tracking device and the remaining asset tracking devices of each other, or any combination thereof.

Clause 15. The method of any of clauses 1 to 14, further comprising: determining one or more distances between the asset tracking device and one or more remaining asset tracking devices of the plurality of asset tracking devices; and transmitting the one or more distances.

Clause 16. The method of clause 15, wherein: a location of the asset tracking device is updated based on the one or more distances, a confidence in the location of the asset tracking device is increased based on the one or more distances, the one or more distances between the asset tracking device and the one or more remaining asset tracking devices are updated based on reported locations of the one or more remaining asset tracking devices, or any combination thereof.

Clause 17. The method of any of clauses 1 to 16, wherein: the set of group scheduling parameters is received from a server or a lead asset tracking device of the plurality of asset tracking devices, and the one or more positioning measurements are transmitted to the server or the lead asset tracking device for forwarding to the server.

Clause 18. A method of communication performed by a network entity, comprising: receiving one or more measurements from at least one asset tracking device of a plurality of asset tracking devices assigned to a plurality of assets in a shipment, wherein the one or more measurements are associated with a potentially spurious asset tracking device; obtaining tracker information associated with the potentially spurious asset tracking device; determining, based on the tracker information, whether the potentially spurious asset tracking device is a spurious asset tracking device; and transmitting, based on a determination that the potentially spurious asset tracking device is a spurious asset tracking device, an alert indicating a presence of the spurious asset tracking device.

Clause 19. The method of clause 18, wherein obtaining the tracker information comprises: transmitting, to a server with which the network entity has an information exchange agreement, a request for the tracker information associated with the potentially spurious asset tracking device; and receiving the tracker information from the server.

Clause 20. The method of clause 19, wherein the potentially spurious asset tracking device is from a different ecosystem from the plurality of asset tracking devices.

Clause 21. The method of any of clauses 18 to 20, further comprising: transmitting, based on a determination that the potentially spurious asset tracking device is not a spurious asset tracking device, an indication to ignore transmissions of the potentially spurious asset tracking device; and adding the potentially spurious asset tracking device to a safe list.

Clause 22. The method of any of clauses 18 to 21, wherein the one or more measurements comprise: header information from one or more messages transmitted by the potentially spurious asset tracking device, and a group identifier associated with the potentially spurious asset tracking device that does not match a group identifier associated with the plurality of asset tracking devices.

Clause 23. The method of any of clauses 18, 19, 21, and 22, wherein: the potentially spurious asset tracking device is from a same ecosystem as the plurality of asset tracking devices, and the potentially spurious asset tracking device is a compromised asset tracking device.

Clause 24. The method of clause 23, wherein the potentially spurious asset tracking device is determined to be the compromised asset tracking device based on the potentially spurious asset tracking device having: a different transmission periodicity than remaining asset tracking devices of the plurality of asset tracking devices, a different transmit power than remaining asset tracking devices of the plurality of asset tracking devices, a different information element format than remaining asset tracking devices of the plurality of asset tracking devices, a different trajectory than remaining asset tracking devices of the plurality of asset tracking devices prior to the compromised asset tracking device joining the plurality of asset tracking devices, or any combination thereof.

Clause 25. The method of any of clauses 18 to 24, wherein the plurality of asset tracking devices is configured to perform listening operations and transmission operations according to a defined schedule to detect the presence of the potentially spurious asset tracking device.

Clause 26. The method of any of clauses 18 to 25, wherein the tracker information comprises: whether the potentially spurious asset tracking device is being used by a consumer, whether the potentially spurious asset tracking device is being used for inventory tracking, whether the potentially spurious asset tracking device has been reported as lost, a last known location of the potentially spurious asset tracking device, a last known trajectory of the potentially spurious asset tracking device, or any combination thereof.

Clause 27. The method of any of clauses 18 to 26, wherein the alert is transmitted to: a server associated with the spurious asset tracking device, a device within a threshold distance of the spurious asset tracking device to enable a user to visually inspect the spurious asset tracking device, or any combination thereof.

Clause 28. The method of any of clauses 18 to 27, wherein the network entity is: a server, or a relay node.

Clause 29. An asset tracking device, comprising: one or more memories; one or more transceivers; and one or more processors communicatively coupled to the one or more memories and the one or more transceivers, the one or more processors, either alone or in combination, configured to: receive, via the one or more transceivers, a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtain one or more positioning measurements; transmit, via the one or more transceivers, the one or more positioning measurements; synchronize a local clock of the asset tracking device to a global time protocol; and transition to a sleep mode.

Clause 30. The asset tracking device of clause 29, wherein the time interval is a smallest time interval between consecutive wakeup times supported by the plurality of asset tracking devices.

Clause 31. The asset tracking device of any of clauses 29 to 30, wherein: a first subset of the plurality of asset tracking devices is configured to wake up every N wakeup times of the consecutive wakeup times, and N is greater than or equal to 1.

Clause 32. The asset tracking device of clause 31, wherein: a second subset of the plurality of asset tracking devices is configured to wake up every M wakeup times of the consecutive wakeup times, and M is greater than or equal to 1.

Clause 33. The asset tracking device of clause 32, wherein: the first subset of the plurality of asset tracking devices is configured to report a first type of positioning measurements, and the second subset of the plurality of asset tracking devices is configured to report a second type of positioning measurements different than the first type of positioning measurements.

Clause 34. The asset tracking device of any of clauses 29 to 33, wherein: the set of wakeup times comprises every N wakeup times of the consecutive wakeup times until the target stop of the asset tracking device, where N is greater than 1, or the set of wakeup times comprises all wakeup times of the consecutive wakeup times until the target stop of the asset tracking device.

Clause 35. The asset tracking device of any of clauses 29 to 34, wherein the one or more processors, either alone or in combination, are further configured to, at each wakeup time of at least the set of wakeup times of the consecutive wakeup times: obtain one or more sensor measurements from one or more sensors of the asset tracking device; and transmit, via the one or more transceivers, the one or more sensor measurements.

Clause 36. The asset tracking device of clause 35, wherein the one or more processors configured to obtain the one or more sensor measurements comprises the one or more processors, either alone or in combination, configured to: obtain one or more temperature measurements from one or more temperature sensors of the asset tracking device; obtain one or more humidity measurements from one or more humidity sensors of the asset tracking device; obtain one or more accelerometer measurements from one or more accelerometers of the asset tracking device; obtain one or more gyrometric measurements from one or more gyroscopic sensors of the asset tracking device; obtain one or more barometric measurements from one or more barometric sensors of the asset tracking device; obtain one or more light measurements from one or more light sensors of the asset tracking device; obtain one or more noise measurements from one or more microphones of the asset tracking device; or any combination thereof.

Clause 37. The asset tracking device of any of clauses 29 to 36, wherein the one or more processors configured to obtain the one or more positioning measurements comprises the one or more processors, either alone or in combination, configured to: obtain one or more global navigation satellite system (GNSS) measurements; obtain one or more measurements of one or more cellular base stations; obtain one or more measurements of one or more wireless local area network (WLAN) access points; obtain one or more measurements of one or more BLUETOOTH® beacons; or any combination thereof.

Clause 38. The asset tracking device of any of clauses 29 to 37, wherein the one or more processors, either alone or in combination, are further configured to: transmit, via the one or more transceivers, based on a location of the asset tracking device being within a threshold distance of the target stop of the asset tracking device, positioning measurements independently of the group scheduling parameters.

Clause 39. The asset tracking device of any of clauses 29 to 38, wherein the one or more processors, either alone or in combination, are further configured to trigger an alert in response to: the asset tracking device not reaching the target stop of the asset tracking device while remaining asset tracking devices of the plurality of asset tracking devices have passed the target stop of the asset tracking device, the asset tracking device continuing on the shipment after the target stop of the asset tracking device, a location of the asset tracking device being at a distance greater than a threshold distance from locations of remaining asset tracking devices of the plurality of asset tracking devices, or the asset tracking device ceasing to transmit at each wakeup time of at least the set of wakeup times of the consecutive wakeup times while remaining asset tracking devices of the plurality of asset tracking devices transmit at each wakeup time of at least the set of wakeup times of the consecutive wakeup times.

Clause 40. The asset tracking device of any of clauses 29 to 39, wherein the asset tracking device is added to the plurality of asset tracking devices based on the asset tracking device being on the shipment for greater than a threshold period of time.

Clause 41. The asset tracking device of clause 40, wherein the asset tracking device is determined to be on the shipment based on pattern matches between measurements reported by the asset tracking device and measurements reported by remaining asset tracking devices of the plurality of asset tracking devices of: sensor shock events, temperature changes, light exposures, humidity levels, noise detections, amplitude changes, or any combination thereof.

Clause 42. The asset tracking device of any of clauses 40 to 41, wherein the asset tracking device is determined to be on the shipment based on: a breach of a geofence breached by the remaining asset tracking devices, a manifest of the shipment, a route, a speed, or both of the asset tracking device matching a route, a speed, or both of the remaining asset tracking devices for at least the threshold period of time, a relative distance between the asset tracking device and the remaining asset tracking devices being less than a threshold for at least the threshold period of time, detection by the asset tracking device and the remaining asset tracking devices of the same cellular base stations, BLUETOOTH® beacons, Wi-Fi access points, or any combination thereof, detection by the asset tracking device and the remaining asset tracking devices of each other, or any combination thereof.

Clause 43. The asset tracking device of any of clauses 29 to 42, wherein the one or more processors, either alone or in combination, are further configured to: determine one or more distances between the asset tracking device and one or more remaining asset tracking devices of the plurality of asset tracking devices; and transmit, via the one or more transceivers, the one or more distances.

Clause 44. The asset tracking device of clause 43, wherein: a location of the asset tracking device is updated based on the one or more distances, a confidence in the location of the asset tracking device is increased based on the one or more distances, the one or more distances between the asset tracking device and the one or more remaining asset tracking devices are updated based on reported locations of the one or more remaining asset tracking devices, or any combination thereof.

Clause 45. The asset tracking device of any of clauses 29 to 44, wherein: the set of group scheduling parameters is received from a server or a lead asset tracking device of the plurality of asset tracking devices, and the one or more positioning measurements are transmitted to the server or the lead asset tracking device for forwarding to the server.

Clause 46. A network entity, comprising: one or more memories; one or more transceivers; and one or more processors communicatively coupled to the one or more memories and the one or more transceivers, the one or more processors, either alone or in combination, configured to: receive, via the one or more transceivers, one or more measurements from at least one asset tracking device of a plurality of asset tracking devices assigned to a plurality of assets in a shipment, wherein the one or more measurements are associated with a potentially spurious asset tracking device; obtain tracker information associated with the potentially spurious asset tracking device; determine, based on the tracker information, whether the potentially spurious asset tracking device is a spurious asset tracking device; and transmit, via the one or more transceivers, based on a determination that the potentially spurious asset tracking device is a spurious asset tracking device, an alert indicating a presence of the spurious asset tracking device.

Clause 47. The network entity of clause 46, wherein the one or more processors configured to obtain the tracker information comprises the one or more processors, either alone or in combination, configured to: transmit, via the one or more transceivers, to a server with which the network entity has an information exchange agreement, a request for the tracker information associated with the potentially spurious asset tracking device; and receive, via the one or more transceivers, the tracker information from the server.

Clause 48. The network entity of clause 47, wherein the potentially spurious asset tracking device is from a different ecosystem from the plurality of asset tracking devices.

Clause 49. The network entity of any of clauses 46 to 48, wherein the one or more processors, either alone or in combination, are further configured to: transmit, via the one or more transceivers, based on a determination that the potentially spurious asset tracking device is not a spurious asset tracking device, an indication to ignore transmissions of the potentially spurious asset tracking device; and add the potentially spurious asset tracking device to a safe list.

Clause 50. The network entity of any of clauses 46 to 49, wherein the one or more measurements comprise: header information from one or more messages transmitted by the potentially spurious asset tracking device, and a group identifier associated with the potentially spurious asset tracking device that does not match a group identifier associated with the plurality of asset tracking devices.

Clause 51. The network entity of any of clauses 46, 47, 49, and 50, wherein: the potentially spurious asset tracking device is from a same ecosystem as the plurality of asset tracking devices, and the potentially spurious asset tracking device is a compromised asset tracking device.

Clause 52. The network entity of clause 51, wherein the potentially spurious asset tracking device is determined to be the compromised asset tracking device based on the potentially spurious asset tracking device having: a different transmission periodicity than remaining asset tracking devices of the plurality of asset tracking devices, a different transmit power than remaining asset tracking devices of the plurality of asset tracking devices, a different information element format than remaining asset tracking devices of the plurality of asset tracking devices, a different trajectory than remaining asset tracking devices of the plurality of asset tracking devices prior to the compromised asset tracking device joining the plurality of asset tracking devices, or any combination thereof.

Clause 53. The network entity of any of clauses 46 to 52, wherein the plurality of asset tracking devices is configured to perform listening operations and transmission operations according to a defined schedule to detect the presence of the potentially spurious asset tracking device.

Clause 54. The network entity of any of clauses 46 to 53, wherein the tracker information comprises: whether the potentially spurious asset tracking device is being used by a consumer, whether the potentially spurious asset tracking device is being used for inventory tracking, whether the potentially spurious asset tracking device has been reported as lost, a last known location of the potentially spurious asset tracking device, a last known trajectory of the potentially spurious asset tracking device, or any combination thereof.

Clause 55. The network entity of any of clauses 46 to 54, wherein the alert is transmitted to: a server associated with the spurious asset tracking device, a device within a threshold distance of the spurious asset tracking device to enable a user to visually inspect the spurious asset tracking device, or any combination thereof.

Clause 56. The network entity of any of clauses 46 to 55, wherein the network entity is: a server, or a relay node.

Clause 57. An asset tracking device, comprising: means for receiving a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: means for obtaining one or more positioning measurements; means for transmitting the one or more positioning measurements; means for synchronizing a local clock of the asset tracking device to a global time protocol; and means for transitioning to a sleep mode.

Clause 58. The asset tracking device of clause 57, wherein the time interval is a smallest time interval between consecutive wakeup times supported by the plurality of asset tracking devices.

Clause 59. The asset tracking device of any of clauses 57 to 58, wherein: a first subset of the plurality of asset tracking devices is configured to wake up every N wakeup times of the consecutive wakeup times, and N is greater than or equal to 1.

Clause 60. The asset tracking device of clause 59, wherein: a second subset of the plurality of asset tracking devices is configured to wake up every M wakeup times of the consecutive wakeup times, and M is greater than or equal to 1.

Clause 61. The asset tracking device of clause 60, wherein: the first subset of the plurality of asset tracking devices is configured to report a first type of positioning measurements, and the second subset of the plurality of asset tracking devices is configured to report a second type of positioning measurements different than the first type of positioning measurements.

Clause 62. The asset tracking device of any of clauses 57 to 61, wherein: the set of wakeup times comprises every N wakeup times of the consecutive wakeup times until the target stop of the asset tracking device, where N is greater than 1, or the set of wakeup times comprises all wakeup times of the consecutive wakeup times until the target stop of the asset tracking device.

Clause 63. The asset tracking device of any of clauses 57 to 62, further comprising, at each wakeup time of at least the set of wakeup times of the consecutive wakeup times: means for obtaining one or more sensor measurements from one or more sensors of the asset tracking device; and means for transmitting the one or more sensor measurements.

Clause 64. The asset tracking device of clause 63, wherein the means for obtaining the one or more sensor measurements comprises: means for obtaining one or more temperature measurements from one or more temperature sensors of the asset tracking device; means for obtaining one or more humidity measurements from one or more humidity sensors of the asset tracking device; means for obtaining one or more accelerometer measurements from one or more accelerometers of the asset tracking device; means for obtaining one or more gyrometric measurements from one or more gyroscopic sensors of the asset tracking device; means for obtaining one or more barometric measurements from one or more barometric sensors of the asset tracking device; means for obtaining one or more light measurements from one or more light sensors of the asset tracking device; means for obtaining one or more noise measurements from one or more microphones of the asset tracking device; or any combination thereof.

Clause 65. The asset tracking device of any of clauses 57 to 64, wherein the means for obtaining the one or more positioning measurements comprises: means for obtaining one or more global navigation satellite system (GNSS) measurements; means for obtaining one or more measurements of one or more cellular base stations; means for obtaining one or more measurements of one or more wireless local area network (WLAN) access points; means for obtaining one or more measurements of one or more BLUETOOTH® beacons; or any combination thereof.

Clause 66. The asset tracking device of any of clauses 57 to 65, further comprising: means for transmitting, based on a location of the asset tracking device being within a threshold distance of the target stop of the asset tracking device, positioning measurements independently of the group scheduling parameters.

Clause 67. The asset tracking device of any of clauses 57 to 66, further comprising means for triggering an alert in response to: the asset tracking device not reaching the target stop of the asset tracking device while remaining asset tracking devices of the plurality of asset tracking devices have passed the target stop of the asset tracking device, the asset tracking device continuing on the shipment after the target stop of the asset tracking device, a location of the asset tracking device being at a distance greater than a threshold distance from locations of remaining asset tracking devices of the plurality of asset tracking devices, or the asset tracking device ceasing to transmit at each wakeup time of at least the set of wakeup times of the consecutive wakeup times while remaining asset tracking devices of the plurality of asset tracking devices transmit at each wakeup time of at least the set of wakeup times of the consecutive wakeup times.

Clause 68. The asset tracking device of any of clauses 57 to 67, wherein the asset tracking device is added to the plurality of asset tracking devices based on the asset tracking device being on the shipment for greater than a threshold period of time.

Clause 69. The asset tracking device of clause 68, wherein the asset tracking device is determined to be on the shipment based on pattern matches between measurements reported by the asset tracking device and measurements reported by remaining asset tracking devices of the plurality of asset tracking devices of: sensor shock events, temperature changes, light exposures, humidity levels, noise detections, amplitude changes, or any combination thereof.

Clause 70. The asset tracking device of any of clauses 68 to 69, wherein the asset tracking device is determined to be on the shipment based on: a breach of a geofence breached by the remaining asset tracking devices, a manifest of the shipment, a route, a speed, or both of the asset tracking device matching a route, a speed, or both of the remaining asset tracking devices for at least the threshold period of time, a relative distance between the asset tracking device and the remaining asset tracking devices being less than a threshold for at least the threshold period of time, detection by the asset tracking device and the remaining asset tracking devices of the same cellular base stations, BLUETOOTH® beacons, Wi-Fi access points, or any combination thereof, detection by the asset tracking device and the remaining asset tracking devices of each other, or any combination thereof.

Clause 71. The asset tracking device of any of clauses 57 to 70, further comprising: means for determining one or more distances between the asset tracking device and one or more remaining asset tracking devices of the plurality of asset tracking devices; and means for transmitting the one or more distances.

Clause 72. The asset tracking device of clause 71, wherein: a location of the asset tracking device is updated based on the one or more distances, a confidence in the location of the asset tracking device is increased based on the one or more distances, the one or more distances between the asset tracking device and the one or more remaining asset tracking devices are updated based on reported locations of the one or more remaining asset tracking devices, or any combination thereof.

Clause 73. The asset tracking device of any of clauses 57 to 72, wherein: the set of group scheduling parameters is received from a server or a lead asset tracking device of the plurality of asset tracking devices, and the one or more positioning measurements are transmitted to the server or the lead asset tracking device for forwarding to the server.

Clause 74. A network entity, comprising: means for receiving one or more measurements from at least one asset tracking device of a plurality of asset tracking devices assigned to a plurality of assets in a shipment, wherein the one or more measurements are associated with a potentially spurious asset tracking device; means for obtaining tracker information associated with the potentially spurious asset tracking device; means for determining, based on the tracker information, whether the potentially spurious asset tracking device is a spurious asset tracking device; and means for transmitting, based on a determination that the potentially spurious asset tracking device is a spurious asset tracking device, an alert indicating a presence of the spurious asset tracking device.

Clause 75. The network entity of clause 74, wherein the means for obtaining the tracker information comprises: means for transmitting, to a server with which the network entity has an information exchange agreement, a request for the tracker information associated with the potentially spurious asset tracking device; and means for receiving the tracker information from the server.

Clause 76. The network entity of clause 75, wherein the potentially spurious asset tracking device is from a different ecosystem from the plurality of asset tracking devices.

Clause 77. The network entity of any of clauses 74 to 76, further comprising: means for transmitting, based on a determination that the potentially spurious asset tracking device is not a spurious asset tracking device, an indication to ignore transmissions of the potentially spurious asset tracking device; and means for adding the potentially spurious asset tracking device to a safe list.

Clause 78. The network entity of any of clauses 74 to 77, wherein the one or more measurements comprise: header information from one or more messages transmitted by the potentially spurious asset tracking device, and a group identifier associated with the potentially spurious asset tracking device that does not match a group identifier associated with the plurality of asset tracking devices.

Clause 79. The network entity of any of clauses 74, 75, 77, and 78, wherein: the potentially spurious asset tracking device is from a same ecosystem as the plurality of asset tracking devices, and the potentially spurious asset tracking device is a compromised asset tracking device.

Clause 80. The network entity of clause 79, wherein the potentially spurious asset tracking device is determined to be the compromised asset tracking device based on the potentially spurious asset tracking device having: a different transmission periodicity than remaining asset tracking devices of the plurality of asset tracking devices, a different transmit power than remaining asset tracking devices of the plurality of asset tracking devices, a different information element format than remaining asset tracking devices of the plurality of asset tracking devices, a different trajectory than remaining asset tracking devices of the plurality of asset tracking devices prior to the compromised asset tracking device joining the plurality of asset tracking devices, or any combination thereof.

Clause 81. The network entity of any of clauses 74 to 80, wherein the plurality of asset tracking devices is configured to perform listening operations and transmission operations according to a defined schedule to detect the presence of the potentially spurious asset tracking device.

Clause 82. The network entity of any of clauses 74 to 81, wherein the tracker information comprises: whether the potentially spurious asset tracking device is being used by a consumer, whether the potentially spurious asset tracking device is being used for inventory tracking, whether the potentially spurious asset tracking device has been reported as lost, a last known location of the potentially spurious asset tracking device, a last known trajectory of the potentially spurious asset tracking device, or any combination thereof.

Clause 83. The network entity of any of clauses 74 to 82, wherein the alert is transmitted to: a server associated with the spurious asset tracking device, a device within a threshold distance of the spurious asset tracking device to enable a user to visually inspect the spurious asset tracking device, or any combination thereof.

Clause 84. The network entity of any of clauses 74 to 83, wherein the network entity is: a server, or a relay node.

Clause 85. A non-transitory computer-readable medium storing computer-executable instructions that, when executed by an asset tracking device, cause the asset tracking device to: receive a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and at each wakeup time of at least a set of wakeup times of the consecutive wakeup times: obtain one or more positioning measurements; transmit the one or more positioning measurements; synchronize a local clock of the asset tracking device to a global time protocol; and transition to a sleep mode.

Clause 86. The non-transitory computer-readable medium of clause 85, wherein the time interval is a smallest time interval between consecutive wakeup times supported by the plurality of asset tracking devices.

Clause 87. The non-transitory computer-readable medium of any of clauses 85 to 86, wherein: a first subset of the plurality of asset tracking devices is configured to wake up every N wakeup times of the consecutive wakeup times, and N is greater than or equal to 1.

Clause 88. The non-transitory computer-readable medium of clause 87, wherein: a second subset of the plurality of asset tracking devices is configured to wake up every M wakeup times of the consecutive wakeup times, and M is greater than or equal to 1.

Clause 89. The non-transitory computer-readable medium of clause 88, wherein: the first subset of the plurality of asset tracking devices is configured to report a first type of positioning measurements, and the second subset of the plurality of asset tracking devices is configured to report a second type of positioning measurements different than the first type of positioning measurements.

Clause 90. The non-transitory computer-readable medium of any of clauses 85 to 89, wherein: the set of wakeup times comprises every N wakeup times of the consecutive wakeup times until the target stop of the asset tracking device, where N is greater than 1, or the set of wakeup times comprises all wakeup times of the consecutive wakeup times until the target stop of the asset tracking device.

Clause 91. The non-transitory computer-readable medium of any of clauses 85 to 90, further comprising computer-executable instructions that, when executed by the asset tracking device, cause the asset tracking device to, at each wakeup time of at least the set of wakeup times of the consecutive wakeup times: obtain one or more sensor measurements from one or more sensors of the asset tracking device; and transmit the one or more sensor measurements.

Clause 92. The non-transitory computer-readable medium of clause 91, wherein the computer-executable instructions that, when executed by the asset tracking device, cause the asset tracking device to obtain the one or more sensor measurements comprise computer-executable instructions that, when executed by the asset tracking device, cause the asset tracking device to: obtain one or more temperature measurements from one or more temperature sensors of the asset tracking device; obtain one or more humidity measurements from one or more humidity sensors of the asset tracking device; obtain one or more accelerometer measurements from one or more accelerometers of the asset tracking device; obtain one or more gyrometric measurements from one or more gyroscopic sensors of the asset tracking device; obtain one or more barometric measurements from one or more barometric sensors of the asset tracking device; obtain one or more light measurements from one or more light sensors of the asset tracking device; obtain one or more noise measurements from one or more microphones of the asset tracking device; or any combination thereof.

Clause 93. The non-transitory computer-readable medium of any of clauses 85 to 92, wherein the computer-executable instructions that, when executed by the asset tracking device, cause the asset tracking device to obtain the one or more positioning measurements comprise computer-executable instructions that, when executed by the asset tracking device, cause the asset tracking device to: obtain one or more global navigation satellite system (GNSS) measurements; obtain one or more measurements of one or more cellular base stations; obtain one or more measurements of one or more wireless local area network (WLAN) access points; obtain one or more measurements of one or more BLUETOOTH® beacons; or any combination thereof.

Clause 94. The non-transitory computer-readable medium of any of clauses 85 to 93, further comprising computer-executable instructions that, when executed by the asset tracking device, cause the asset tracking device to: transmit, based on a location of the asset tracking device being within a threshold distance of the target stop of the asset tracking device, positioning measurements independently of the group scheduling parameters.

Clause 95. The non-transitory computer-readable medium of any of clauses 85 to 94, further comprising computer-executable instructions that, when executed by the asset tracking device, cause the asset tracking device to trigger an alert in response to: the asset tracking device not reaching the target stop of the asset tracking device while remaining asset tracking devices of the plurality of asset tracking devices have passed the target stop of the asset tracking device, the asset tracking device continuing on the shipment after the target stop of the asset tracking device, a location of the asset tracking device being at a distance greater than a threshold distance from locations of remaining asset tracking devices of the plurality of asset tracking devices, or the asset tracking device ceasing to transmit at each wakeup time of at least the set of wakeup times of the consecutive wakeup times while remaining asset tracking devices of the plurality of asset tracking devices transmit at each wakeup time of at least the set of wakeup times of the consecutive wakeup times.

Clause 96. The non-transitory computer-readable medium of any of clauses 85 to 95, wherein the asset tracking device is added to the plurality of asset tracking devices based on the asset tracking device being on the shipment for greater than a threshold period of time.

Clause 97. The non-transitory computer-readable medium of any of clauses 95 to 96, wherein the asset tracking device is determined to be on the shipment based on pattern matches between measurements reported by the asset tracking device and measurements reported by remaining asset tracking devices of the plurality of asset tracking devices of:

sensor shock events, temperature changes, light exposures, humidity levels, noise detections, amplitude changes, or any combination thereof.

Clause 98. The non-transitory computer-readable medium of any of clauses 95 to 97, wherein the asset tracking device is determined to be on the shipment based on: a breach of a geofence breached by the remaining asset tracking devices, a manifest of the shipment, a route, a speed, or both of the asset tracking device matching a route, a speed, or both of the remaining asset tracking devices for at least the threshold period of time, a relative distance between the asset tracking device and the remaining asset tracking devices being less than a threshold for at least the threshold period of time, detection by the asset tracking device and the remaining asset tracking devices of the same cellular base stations, BLUETOOTH® beacons, Wi-Fi access points, or any combination thereof, detection by the asset tracking device and the remaining asset tracking devices of each other, or any combination thereof.

Clause 99. The non-transitory computer-readable medium of any of clauses 85 to 98, further comprising computer-executable instructions that, when executed by the asset tracking device, cause the asset tracking device to: determine one or more distances between the asset tracking device and one or more remaining asset tracking devices of the plurality of asset tracking devices; and transmit the one or more distances.

Clause 100. The non-transitory computer-readable medium of any of clauses 98 to 99, wherein: a location of the asset tracking device is updated based on the one or more distances, a confidence in the location of the asset tracking device is increased based on the one or more distances, the one or more distances between the asset tracking device and the one or more remaining asset tracking devices are updated based on reported locations of the one or more remaining asset tracking devices, or any combination thereof.

Clause 101. The non-transitory computer-readable medium of any of clauses 85 to 100, wherein: the set of group scheduling parameters is received from a server or a lead asset tracking device of the plurality of asset tracking devices, and the one or more positioning measurements are transmitted to the server or the lead asset tracking device for forwarding to the server.

Clause 102. A non-transitory computer-readable medium storing computer-executable instructions that, when executed by a network entity, cause the network entity to: receive one or more measurements from at least one asset tracking device of a plurality of asset tracking devices assigned to a plurality of assets in a shipment, wherein the one or more measurements are associated with a potentially spurious asset tracking device; obtain tracker information associated with the potentially spurious asset tracking device; determine, based on the tracker information, whether the potentially spurious asset tracking device is a spurious asset tracking device; and transmit, based on a determination that the potentially spurious asset tracking device is a spurious asset tracking device, an alert indicating a presence of the spurious asset tracking device.

Clause 103. The non-transitory computer-readable medium of any of clauses 101 to 102, wherein the computer-executable instructions that, when executed by the network entity, cause the network entity to obtain the tracker information comprise computer-executable instructions that, when executed by the network entity, cause the network entity to: transmit, to a server with which the network entity has an information exchange agreement, a request for the tracker information associated with the potentially spurious asset tracking device; and receive the tracker information from the server.

Clause 104. The non-transitory computer-readable medium of any of clauses 102 to 103, wherein the potentially spurious asset tracking device is from a different ecosystem from the plurality of asset tracking devices.

Clause 105. The non-transitory computer-readable medium of any of clauses 101 to 104, further comprising computer-executable instructions that, when executed by the network entity, cause the network entity to: transmit, based on a determination that the potentially spurious asset tracking device is not a spurious asset tracking device, an indication to ignore transmissions of the potentially spurious asset tracking device; and add the potentially spurious asset tracking device to a safe list.

Clause 106. The non-transitory computer-readable medium of any of clauses 101 to 105, wherein the one or more measurements comprise: header information from one or more messages transmitted by the potentially spurious asset tracking device, and a group identifier associated with the potentially spurious asset tracking device that does not match a group identifier associated with the plurality of asset tracking devices.

Clause 107. The non-transitory computer-readable medium of any of clauses 101, 102, 105, and 106, wherein: the potentially spurious asset tracking device is from a same ecosystem as the plurality of asset tracking devices, and the potentially spurious asset tracking device is a compromised asset tracking device.

Clause 108. The non-transitory computer-readable medium of any of clauses 106 to 107, wherein the potentially spurious asset tracking device is determined to be the compromised asset tracking device based on the potentially spurious asset tracking device having: a different transmission periodicity than remaining asset tracking devices of the plurality of asset tracking devices, a different transmit power than remaining asset tracking devices of the plurality of asset tracking devices, a different information element format than remaining asset tracking devices of the plurality of asset tracking devices, a different trajectory than remaining asset tracking devices of the plurality of asset tracking devices prior to the compromised asset tracking device joining the plurality of asset tracking devices, or any combination thereof.

Clause 109. The non-transitory computer-readable medium of any of clauses 101 to 108, wherein the plurality of asset tracking devices is configured to perform listening operations and transmission operations according to a defined schedule to detect the presence of the potentially spurious asset tracking device.

Clause 110. The non-transitory computer-readable medium of any of clauses 101 to 109, wherein the tracker information comprises: whether the potentially spurious asset tracking device is being used by a consumer, whether the potentially spurious asset tracking device is being used for inventory tracking, whether the potentially spurious asset tracking device has been reported as lost, a last known location of the potentially spurious asset tracking device, a last known trajectory of the potentially spurious asset tracking device, or any combination thereof.

Clause 111. The non-transitory computer-readable medium of any of clauses 101 to 110, wherein the alert is transmitted to: a server associated with the spurious asset tracking device, a device within a threshold distance of the spurious asset tracking device to enable a user to visually inspect the spurious asset tracking device, or any combination thereof.

Clause 112. The non-transitory computer-readable medium of any of clauses 101 to 111, wherein the network entity is: a server, or a relay node.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by an asset tracking device, comprising:
receiving a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and
at each wakeup time of at least a set of wakeup times of the consecutive wakeup times:
obtaining one or more positioning measurements;
transmitting the one or more positioning measurements;
synchronizing a local clock of the asset tracking device to a global time protocol; and
transitioning to a sleep mode.

2. The method of claim 1, wherein the time interval is a smallest time interval between consecutive wakeup times supported by the plurality of asset tracking devices.

3. The method of claim 1, wherein:
a first subset of the plurality of asset tracking devices is configured to wake up every N wakeup times of the consecutive wakeup times, and
N is greater than or equal to 1.

4. The method of claim 3, wherein:
a second subset of the plurality of asset tracking devices is configured to wake up every M wakeup times of the consecutive wakeup times, and
M is greater than or equal to 1.

5. The method of claim 4, wherein:
the first subset of the plurality of asset tracking devices is configured to report a first type of positioning measurements, and
the second subset of the plurality of asset tracking devices is configured to report a second type of positioning measurements different than the first type of positioning measurements.

6. The method of claim 1, wherein:
the set of wakeup times comprises every N wakeup times of the consecutive wakeup times until the target stop of the asset tracking device, where N is greater than 1, or
the set of wakeup times comprises all wakeup times of the consecutive wakeup times until the target stop of the asset tracking device.

7. The method of claim 1, further comprising, at each wakeup time of at least the set of wakeup times of the consecutive wakeup times:
obtaining one or more sensor measurements from one or more sensors of the asset tracking device; and
transmitting the one or more sensor measurements.

8. The method of claim 7, wherein obtaining the one or more sensor measurements comprises:
obtaining one or more temperature measurements from one or more temperature sensors of the asset tracking device;
obtaining one or more humidity measurements from one or more humidity sensors of the asset tracking device;
obtaining one or more accelerometer measurements from one or more accelerometers of the asset tracking device;
obtaining one or more gyrometric measurements from one or more gyroscopic sensors of the asset tracking device;
obtaining one or more barometric measurements from one or more barometric sensors of the asset tracking device;
obtaining one or more light measurements from one or more light sensors of the asset tracking device;
obtaining one or more noise measurements from one or more microphones of the asset tracking device; or
any combination thereof.

9. The method of claim 1, wherein obtaining the one or more positioning measurements comprises:
obtaining one or more global navigation satellite system (GNSS) measurements;
obtaining one or more measurements of one or more cellular base stations;
obtaining one or more measurements of one or more wireless local area network (WLAN) access points;
obtaining one or more measurements of one or more BLUETOOTH® beacons; or
any combination thereof.

10. The method of claim 1, further comprising:
transmitting, based on a location of the asset tracking device being within a threshold distance of the target stop of the asset tracking device, positioning measurements independently of the group scheduling parameters.

11. The method of claim 1, further comprising triggering an alert in response to:
the asset tracking device not reaching the target stop of the asset tracking device while remaining asset tracking devices of the plurality of asset tracking devices have passed the target stop of the asset tracking device,
the asset tracking device continuing on the shipment after the target stop of the asset tracking device,
a location of the asset tracking device being at a distance greater than a threshold distance from locations of remaining asset tracking devices of the plurality of asset tracking devices, or
the asset tracking device ceasing to transmit at each wakeup time of at least the set of wakeup times of the consecutive wakeup times while remaining asset tracking devices of the plurality of asset tracking devices transmit at each wakeup time of at least the set of wakeup times of the consecutive wakeup times.

12. The method of claim 1, wherein the asset tracking device is added to the plurality of asset tracking devices based on the asset tracking device being on the shipment for greater than a threshold period of time.

13. The method of claim 12, wherein the asset tracking device is determined to be on the shipment based on pattern matches between measurements reported by the asset tracking device and measurements reported by remaining asset tracking devices of the plurality of asset tracking devices of:
sensor shock events,
temperature changes,
light exposures,
humidity levels,
noise detections,
amplitude changes, or
any combination thereof.

14. The method of claim 12, wherein the asset tracking device is determined to be on the shipment based on:
a breach of a geofence breached by the remaining asset tracking devices,
a manifest of the shipment,
a route, a speed, or both of the asset tracking device matching a route, a speed, or both of the remaining asset tracking devices for at least the threshold period of time,
a relative distance between the asset tracking device and the remaining asset tracking devices being less than a threshold for at least the threshold period of time,
detection by the asset tracking device and the remaining asset tracking devices of the same cellular base stations, BLUETOOTH® beacons, Wi-Fi access points, or any combination thereof,
detection by the asset tracking device and the remaining asset tracking devices of each other, or
any combination thereof.

15. The method of claim 1, further comprising:
determining one or more distances between the asset tracking device and one or more remaining asset tracking devices of the plurality of asset tracking devices; and
transmitting the one or more distances.

16. The method of claim 15, wherein:
a location of the asset tracking device is updated based on the one or more distances,
a confidence in the location of the asset tracking device is increased based on the one or more distances,
the one or more distances between the asset tracking device and the one or more remaining asset tracking devices are updated based on reported locations of the one or more remaining asset tracking devices, or
any combination thereof.

17. The method of claim 1, wherein:
the set of group scheduling parameters is received from a server or a lead asset tracking device of the plurality of asset tracking devices, and
the one or more positioning measurements are transmitted to the server or the lead asset tracking device for forwarding to the server.

18. A method of communication performed by a network entity, comprising:
receiving one or more measurements from at least one asset tracking device of a plurality of asset tracking devices assigned to a plurality of assets in a shipment, wherein the one or more measurements are associated with a potentially spurious asset tracking device;
obtaining tracker information associated with the potentially spurious asset tracking device;
determining, based on the tracker information, whether the potentially spurious asset tracking device is a spurious asset tracking device; and
transmitting, based on a determination that the potentially spurious asset tracking device is a spurious asset tracking device, an alert indicating a presence of the spurious asset tracking device.

19. The method of claim 18, wherein obtaining the tracker information comprises:
transmitting, to a server with which the network entity has an information exchange agreement, a request for the tracker information associated with the potentially spurious asset tracking device; and
receiving the tracker information from the server.

20. The method of claim 19, wherein the potentially spurious asset tracking device is from a different ecosystem from the plurality of asset tracking devices.

21. The method of claim 18, further comprising:
transmitting, based on a determination that the potentially spurious asset tracking device is not a spurious asset tracking device, an indication to ignore transmissions of the potentially spurious asset tracking device; and
adding the potentially spurious asset tracking device to a safe list.

22. The method of claim 18, wherein the one or more measurements comprise:
header information from one or more messages transmitted by the potentially spurious asset tracking device, and
a group identifier associated with the potentially spurious asset tracking device that does not match a group identifier associated with the plurality of asset tracking devices.

23. The method of claim 18, wherein:
the potentially spurious asset tracking device is from a same ecosystem as the plurality of asset tracking devices, and
the potentially spurious asset tracking device is a compromised asset tracking device.

24. The method of claim 23, wherein the potentially spurious asset tracking device is determined to be the compromised asset tracking device based on the potentially spurious asset tracking device having:
a different transmission periodicity than remaining asset tracking devices of the plurality of asset tracking devices,
a different transmit power than remaining asset tracking devices of the plurality of asset tracking devices,
a different information element format than remaining asset tracking devices of the plurality of asset tracking devices,
a different trajectory than remaining asset tracking devices of the plurality of asset tracking devices prior to the compromised asset tracking device joining the plurality of asset tracking devices, or
any combination thereof.

25. The method of claim 18, wherein the plurality of asset tracking devices is configured to perform listening operations and transmission operations according to a defined schedule to detect the presence of the potentially spurious asset tracking device.

26. The method of claim 18, wherein the tracker information comprises:
whether the potentially spurious asset tracking device is being used by a consumer,
whether the potentially spurious asset tracking device is being used for inventory tracking,
whether the potentially spurious asset tracking device has been reported as lost,
a last known location of the potentially spurious asset tracking device,
a last known trajectory of the potentially spurious asset tracking device, or
any combination thereof.

27. The method of claim 18, wherein the alert is transmitted to:
a server associated with the spurious asset tracking device,
a device within a threshold distance of the spurious asset tracking device to enable a user to visually inspect the spurious asset tracking device, or
any combination thereof.

28. The method of claim 18, wherein the network entity is:
a server, or
a relay node.

29. An asset tracking device, comprising:
one or more memories;
one or more transceivers; and
one or more processors communicatively coupled to the one or more memories and the one or more transceivers, the one or more processors, either alone or in combination, configured to:
receive, via the one or more transceivers, a set of group scheduling parameters for a plurality of asset tracking devices, including the asset tracking device, assigned to a plurality of assets in a shipment, wherein the set of group scheduling parameters comprises a global wakeup start time and a time interval between consecutive wakeup times, wherein the shipment comprises a plurality of stops, wherein the plurality of stops comprises a starting stop, one or more intermediate stops, and an ending stop, and wherein each of the plurality of asset tracking devices has a target stop of the plurality of stops; and
at each wakeup time of at least a set of wakeup times of the consecutive wakeup times:
obtain one or more positioning measurements;
transmit, via the one or more transceivers, the one or more positioning measurements;
synchronize a local clock of the asset tracking device to a global time protocol; and
transition to a sleep mode.

30. A network entity, comprising:
one or more memories;
one or more transceivers; and
one or more processors communicatively coupled to the one or more memories and the one or more transceivers, the one or more processors, either alone or in combination, configured to:
receive, via the one or more transceivers, one or more measurements from at least one asset tracking device of a plurality of asset tracking devices assigned to a plurality of assets in a shipment, wherein the one or more measurements are associated with a potentially spurious asset tracking device;
obtain tracker information associated with the potentially spurious asset tracking device;
determine, based on the tracker information, whether the potentially spurious asset tracking device is a spurious asset tracking device; and
transmit, via the one or more transceivers, based on a determination that the potentially spurious asset tracking device is a spurious asset tracking device, an alert indicating a presence of the spurious asset tracking device.
